(19) United States
(12) Patent Application Publication
(10) Pub. No.: US 2026/0281828 A1
(43) Pub. Date: Sep. 17, 2026

(54) METHOD AND UE FOR ADAPTING PROCEDURES IN A COMMUNICATION SYSTEM

(71) Applicant: Telefonakiebolaget LM Ericsson (publ), Stockholm (SE)

(72) Inventors: Zhixun Tang, Täby (SE); Santhan Thangarasa, Vällingby (SE); Muhammad Ali Kazmi, Reston, VA (US); Ming Li, Stockholm (SE)

(21) Appl. No.: 19/114,914

(22) PCT Filed: Sep. 22, 2023
(86) PCT No.: PCT/SE2023/050929

§ 371 Date: Mar. 25, 2025

(30) Foreign Application Priority Data
Sep. 30, 2022 (WO) PCT/CN2022/123471

(51) Int. Cl. H04W 36/00; H04W 36/08; H04W 36/32; H04W 84/06

(52) U.S. Cl. CPC H04W 36/0058; H04W 36/0072; H04W 36/08; H04W 36/322; H04W 84/06

(57) ABSTRACT

The present disclosure relates to a method performed by a User Equipment (UE) for adapting procedures in a communication system. The UE is an Air-to-ground (ATG) capable UE. The UE is configured for performing one or more measurements on one or more cells of one or more carrier frequencies. The UE is served by a network node in an ATG cell. The UEU determines whether or not the UE is located at least substantially at a cell center of the ATG cell by checking if one or more criteria are met or not. The UE adapts one or more procedures based on a result of the determining.

### TECHNICAL FIELD

The present disclosure relates generally to a User Equipment (UE), a method performed by UE, a network node and a method performed by the network node. More particularly, the present disclosure relates to adapting procedures in a communication system.

### BACKGROUND

### Air-to-Ground (ATG)

An ATG network is basically utilizing the existing mature terrestrial techniques to build one stereoscopic network to provide high quality service for the airplane user. Meanwhile with the introduction of Fifth Generation (5G) technologies into ATG networks, the user on board the airplane could experience the adequate data rates as terrestrial network, therefore the user could have normal online service like online browsing, conference call, real time entertainment and data transmission between cabinets to guarantee the flight safety.

The ATG Base Station (BS) is much more powerful than the legacy terrestrial BS since its coverage range could increase up to 200 km, as shown in FIG. 1, compared with cell coverage up to hundreds of meters of the legacy terrestrial BS. In addition, the ATG BS could also support the mobility of the airplane up to 1200 km/h which is much faster than a high-speed train (HST). In FIG. 1, an example of an ATG communication system comprising four base stations is illustrated where the Inter-Site Distance (ISD) between the base stations is exemplified to be 200 km. The altitude exemplified in FIG. 1 is 10-12 km.

Different with a satellite system which occupy the dedicated channel to provide the service, the ATG system could be deployed co-channel with a terrestrial network which could better utilize the existing spectrum holding in hand.

In addition, the ATG system could provide much higher data rate than the satellite system due to its closer distance between the BS and the UE. In addition, high gain of the antenna array equipped on the airplane is also part of the reason to achieve better performance.

New Radio (NR) support for Non-Terrestrial Networks (NTN) which comprises a satellite component has been specified in Third Generation Partnership Project (3GPP) specifications since Rel-17. The NR NTN specification comprises especially Low-Earth Orbiting (LEO) satellites and Geostationary (GEO) satellites with implicit compatibility to support High Altitude Platform Station (HAPS) and ATG scenarios. The satellite link focuses on providing everywhere connectivity, e.g., when crossing the sea, while the ATG link focuses on providing high-quality data services for all service available areas, e.g., inland and coastline area.

### UE Measurements

The UE performs measurements on one or more Downlink (DL) and/or Uplink (UL) reference signal (RS) of one or more cells in different UE activity states e.g. Radio Resource Control (RRC) idle state, RRC inactive state, RRC connected state etc. The measured cell may belong to or operate on the same carrier frequency as of the serving cell, e.g. intra-frequency carrier, or it may belong to or operate on different carrier frequency as of the serving cell, e.g. non-serving carrier frequency. The non-serving carrier may be called an inter-frequency carrier if the serving and measured cells belong to the same Radio Access Technology (RAT) but having different carriers. The non-serving carrier may be called as inter-RAT carrier if the serving and measured cells belong to different RATs. Examples of downlink RS are signals in Synchronization Signal Block (SSB), Channel State Information-Reference Signal (CSI-RS), Cell Specific Reference signal (CRS), Demodulation Reference Signal (DMRS), Primary Synchronization Signal (PSS), Secondary Synchronization Signal (SSS), signals in Synchronization Signal/Physical Broadcast Channel (SS/PBCH) block (SSB), discovery reference signal (DRS), Positioning Reference Signal (PRS) etc. Examples of uplink RS are signals in Sounding Reference Signal (SRS), DMRS etc.

Each SSB carries a New Radio-Primary Synchronization Signal (NR-PSS), New Radio-Secondary Synchronization Signal (NR-SSS) and New Radio-Physical Broadcast Channel (NR-PBCH) in 4 successive symbols. One or multiple SSBs are transmitted in one SSB burst which is repeated with certain periodicity of e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with respect to reference time, e.g. serving cell's Single Frequency Network (SFN), etc. Therefore, the SMTC occasion may also occur with certain periodicity of e.g. 5 ms, 10 ms, 20 ms, 40 ms, 80 ms and 160 ms.

Examples of measurements are cell identification, e.g. Physical Layer Cell Identity (PCI) acquisition, PSS/SSS detection, cell detection, cell search etc, Reference Symbol Received Power (RSRP), Reference Symbol Received Quality (RSRQ), secondary synchronization RSRP (SS-RSRP), Secondary synchronization Signal-Reference Signal Received Quality (SS-RSRQ), Signal-to-Interference-plus-Noise Ratio (SINR), Reference Signal-Signal-to-Interference-plus-Noise Ratio (RS-SINR), Synchronisation Signal-Signal-to-Interference-plus-Noise Ratio (SS-SINR), Channel State Information-Reference Symbol Received Power (CSI-RSRP), Channel State Information-Reference Signal Received Quality (CSI-RSRQ, Received Signal Strength Indicator (RSSI), acquisition of System Information (SI), Cell Global ID (CGI) acquisition, Reference Signal Time Difference (RSTD), UE Receive-Transmit (RX-TX) time difference measurement, Radio Link Monitoring (RLM), which consists of Out of Synchronization (out of sync) detection and In Synchronization (in-sync) detection etc.

### Measurement Gap Pattern

A Measurement Gap Pattern (MGP) is used by the UE for performing measurements on cells of the non-serving carriers, e.g. inter-frequency carrier, inter-RAT carriers etc. In NR, gaps are also used for measurements on cells of the serving carrier in some scenarios, e.g. if the measured signals, e.g. SSB, are outside the Bandwidth Part (BWP) of the serving cell. The UE is scheduled in the serving cell only within the BWP. During the gap, the UE cannot be scheduled for receiving/transmitting signals in the serving cell. A measurement gap pattern is characterized or defined by several parameters: Measurement Gap Length (MGL), Measurement Gap Repetition Period (MGRP) and measurement gap time offset with respect to reference time, e.g. slot offset with respect to serving cell's SFN such as SFN=0. An example of MGP in NR is shown in FIG. 2. As an example, the MGL can be 1.5, 3, 3.5, 4, 5.5 or 6 ms, and MGRP can be 20, 40, 80 or 160 ms. Such type of MGP is configured by the network node and is also called network controlled or network configurable MGP. Therefore the serving base station is fully aware of the timing of each gap within the MGP. The x-axis in FIG. 2 represents time.

In NR there are two major categories of MGPs: per-UE measurement gap patterns and per-Frequency Range (FR) measurement gap patterns. In NR, the spectrum is divided into two frequency ranges namely FR1 and FR2. FR1 is currently defined from 410 MHz to 7125 MHz. FR2 range is currently defined from 24250 MHz to 71000 MHz. The FR2 range is also interchangeably called millimeter wave (mmwave) and corresponding bands in FR2 are called mmwave bands. In future, more frequency ranges can be specified e.g. FR3. An example of FR3 is a frequency ranging above 71000 MHz or between 7125 MHz and 24250 MHz.

When configured with per-UE MGP, the UE creates gaps on all the serving cells, e.g. Primary Cell (PCell), Primary Secondary Cell (PSCell), Secondary Cell (SCell) etc., regardless of their frequency range. The per-UE MGP can be used by the UE for performing measurements on cells of any carrier frequency belonging to any RAT or frequency range (FR). When configured with per-FR MGP, if the UE supports this capability, the UE creates gaps only on the serving cells of the indicated FR whose carriers are to be measured. For example, if the UE is configured with per-FR1 MGP, then the UE creates measurement gaps only on serving cells, e.g. PCell, PSCell, SCells etc., of FR1 while no gaps are created on serving cells on carriers of FR2. The per-FR1 gaps can be used for measurement on cells of only FR1 carriers. Similarly, per-FR2 gaps when configured are only created on FR2 serving cells and can be used for measurement on cells of only FR2 carriers. Support for per FR gaps is a UE capability, i.e. a certain UE may only support per UE gaps according to their capability.

The example of the MGP shown in FIG. 2 may also be referred to as legacy MGP, conventional MGP or traditional MGP. In the legacy MGP, the gaps occurring every MGRP are always assumed by the UE and base station even when the UE does not use the gaps, e.g. the UE is not performing the measurement. Therefore, during all the gaps within the MGP, the UE is not expected to receive or transmit data.

### Concurrent Measurement Gaps (ConMGs)

ConMGs have been specified in current 3GPP releases. The ConMGs comprise at least two simultaneous configured measurement gap patterns, e.g. at least two individual MGP each of the type shown in FIG. 3. ConMG may also be called simply concurrent gaps. The at least two MGPs may be configured using the same or different MGP related parameters. For example, MGL, MGRP etc. for the at least 2 MGPs may be the same or they may be different. The measurement gaps belonging to different MGPs within the ConMGs may or may not overlap or may partially overlap with respect to each other in time. Examples of different ConMGs with respect to the level of overlap between measurement gaps are shown in FIG. 3.

Five major scenarios for concurrent gaps are illustrated in FIG. 3. The horizontal arrows in FIG. 3 represent time. The white boxes in FIG. 3 represent that MG is configured but not activated and the boxes colored with diagonal lines represent that MG is configured and activated MG.

The scenario (a) in FIG. 3 illustrates two Fully Non-Overlapping (FNO) measurement gap patterns. In the scenario (a), all gap occasions of 2 MGs are disjoint in time. Although here the MGRPs are illustrated as being the same for both measurement gap patterns, this is not a requirement for the scenario to apply. MGRPs can differ between the MGPs, e.g. one MGRP may be 40 ms and the other 40 ms or 80 ms, and the scenario (a) is fulfilled as long as measurement gaps in one MGP never overlap, partially or fully, with a measurement gap in another MGP. In standardization discussions this scenario is referred to as the fully non-overlapping (FNO) scenario.

The scenarios (b) in FIG. 3 illustrate two fully overlapping (FO) measurement gap patterns. Every gap occasion of one MG is fully covered by every gap occasion of another MG with the same periodicity. In either case, one MGP is always contained within the other, and the MGRPs for the two MGPs are the same MGRP. In standardization discussions these scenarios are referred to as fully overlapping (FO) scenarios.

The scenario (c) in FIG. 3 illustrates two measurement gap patterns whose gaps consistently partially overlap each other. Every gap occasion of one MG is partially overlapped by every gap occasion of another MG with the same periodicity. The MGRPs are the same MGRP. In the standardization discussions this scenario is referred to as the Fully-Partial Overlapped (FPO) scenario.

The scenario (d) in FIG. 3 illustrates two measurement gap patterns that at least occasionally fully overlap each other. Every gap occasion of one MG is fully covered by gap occasion of another MG with the different periodicity. For this scenario (d) to apply, the MGRPs have to be different, e.g. one MGRP 40 ms and the other MGRP 80 ms. In the standard this scenario is referred to as the Partially-Fully Overlapped (PFO) scenario.

The scenario (e) in FIG. 3 illustrates two measurement gap patterns whose gaps at least occasionally partially overlap each other. Every gap occasion of one MG is partially covered by gap occasion of another MG with the different periodicity. For this scenario to apply, the MGRPs for the two measurement gap patterns have to be different, e.g. one MGRP is 40 ms and the other MGRP is 80 ms. In the standardization discussion this scenario is referred to as the Partially-Partial Overlapped (PPO) scenario.

### Pre-Configured Gaps

Pre-configured measurement gaps (Pre-MG) have also been specified as part of the Rel-17 Measurement Gaps enhancement. The intention here is to allow the configuration of deactivated measurement gaps, i.e., the UE only uses the configured gaps to perform measurements under certain situations. Hence the term pre-configured. This differs from legacy gaps, since for this new case, the gap is not automatically setup, i.e. activated, upon configuration.

There are two methods for the activation/deactivation of the so called pre-configured measurement gaps: a) autonomous approach and b) network-controlled mechanism. For the first method a), the UE can autonomously discriminate whether there is a need to use the pre-configured gap to perform measurements, e.g., if upon BWP switching, the reference signal is not completely contained within the new active BWP. While for the latter method b), the network, e.g. the base station, explicitly indicates in each BWP configuration whether the pre-configured gap should be activated/deactivated upon switching to this particular BWP. The one or more gaps which are not used for the measurement, e.g. SSB to be measured is within the UE's active BWP, are considered to be deactivated or the status of Pre-MG is set to deactivation. The one or more gaps which are used for the measurement, e.g. SSB to be measured is NOT within the UE's active BWP, are considered to be activated or the status of Pre-MG is set to activation. The UE can be scheduled with data in DL and/or in UL by the base station during the deactivated gaps in the serving cell i.e. when the status of Pre-MG is deactivated. The UE is not expected to receive any data from or transmit any data to the base station during the activated gaps in the serving cell i.e. when the status of Pre-MG is activated. The UE can perform measurements on one or more cells during the activated gaps. Therefore, during the activated gaps, the UE can be scheduled with data in the serving cell. An example of Pre-MG in NR is illustrated in FIG. 4. The x-axis in FIG. 4 represents time. The white bars in FIG. 4 represent a gap not currently used by the UE for measurements that is deactivated. The scrambled bars in FIG. 4 represent a gap currently used by the UE for measurements that is activated.

Time and/or Location Based Cell Reselection and Handover

Time based and/or location based mobilities for NTN may be adopted by ATG. The relevant fundamental RRC parameters are interpreted generally as described below:

### In Idle Mode:

T_{service}, called also as t-Service, is an RRC parameter. It indicates the time information on when a cell provided via NTN quasi-Earth fixed system is going to stop serving the area it is currently covering. It is broadcast by network node to the UE e.g. by the serving cell via system information such as in a System Information Block (SIB). It is time offset with respect to the Coordinated Universal Time (UTC) time. It is therefore expressed in UTC, e.g. in number of seconds, in number of UTC seconds in 10 ms units etc.

For a quasi-earth fixed cell, the UE should start measurements on neighbour cells before T_{service}, and the exact time to start measurements is up to the UE implementation.

For a quasi-earth fixed cell, the same as legacy, the UE shall perform neighbour cell measurements of higher priority NR inter-frequency or inter-RAT frequencies regardless of the distance between the UE and the serving cell reference location.

For a quasi-earth fixed cell, the UE should start measurements on neighbour cells before the serving cell stops covering the current area, regardless of the distance between the UE and the serving cell reference location, or if the legacy Srxlev/Squal condition is met, i.e., serving cell's Srxlev/Squal is better than a threshold.

The UE may choose not to perform neighbour cell measurements of NR intra-frequency or inter-frequency with equal or lower priority, or inter-RAT frequency with lower priority, if the distance between the UE and the serving cell reference location is shorter than a threshold and the legacy Srxlev/Squal condition is met, i.e., serving cell's Srxlev/Squal is better than a threshold.

Location-based measurement initiation is only applied if the cell broadcasts location-related parameters, e.g. a threshold, and by implementation the UE has location information.

D_{distanceThresh}, also called as distanceThresh, is a RRC parameter. It indicates the threshold of distance between the UE and the serving cell reference location, D_{distanceThresh} and the reference location are broadcasted by the network, e.g. by the serving cell via system information. It is expressed in meters e.g. in multiples of 50 m.

For a quasi-earth fixed cell, the same as legacy, the UE shall perform neighbour cell measurements of higher priority NR inter-frequency or inter-RAT frequencies regardless of the distance between the UE and the serving cell reference location. For a quasi-earth fixed cell, the UE should start measurements on neighbour cells before T_{service}, the serving cell stops covering the current area, regardless of if D_{distanceThresh}, the distance between UE and serving cell reference location, or legacy Srxlev/Squal condition, i.e., serving cell's Srxlev/Squal is better than a threshold, is met.

The UE may choose not to perform neighbour cell measurements of NR intra-frequency or inter-frequency with equal or lower priority, or inter-RAT frequency with lower priority, if the distance between the UE and the serving cell reference location is shorter than a threshold D_{distanceThresh} and legacy Srxlev/Squal condition is met, i.e., serving cell's Srxlev/Squal is better than a threshold.

### In Connected Mode:

condEventT1-r17, comprising t1-Threshold-r17 and duration-r17 in [1] indicates time duration [t1, t2] for CHO time trigger event.

| | |
|---|---|
| condEventT1-r17 | SEQUENCE { |
| t1-Threshold-r17 | INTEGER (0..549755813887), |
| duration-r17 | INTEGER (1..6000) |

The UE shall execute a Conditional Handover (CHO) to that candidate cell during the time duration, if all other configured CHO execution conditions will apply and there is only one triggered candidate cell.
eventD1-r17, comprising distanceThreshFromReference1-r17 and distanceThreshFromReference2-r17 indicates distance threshold between the UE and the reference location of serving cell and the target cell for CHO location trigger event.

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525), |
| referenceLocation1-r17 | ReferenceLocation-r17, |
| referenceLocation2-r17 | ReferenceLocation-r17, |
| reportOnLeave-r17 | BOOLEAN, |
| hysteresisLocation-r17 | HysteresisLocation-r17, |
| timeToTrigger-r17 | TimeToTrigger |

The UE shall execute CHO to that candidate cell upon fulfilling eventD1-r17, if all other configured CHO execution conditions will apply and there is only one triggered candidate cell.

### Bandwidth Part Operation

The UE can be configured by the higher layer with a set of BWPs for signal receptions, e.g. Physical downlink control channel (PDCCH), Physical Downlink Shared Channel (PDSCH) etc., by the UE, e.g. DL BWP set e.g. up to 4 DL BWPs, and a set of BWPs for signal transmissions, e.g. Physical Uplink Control Channel (PUCCH), Physical Uplink Shared Channel (PUSCH) by the UE, e.g. UL BWP set e.g. up to 4 UL BWPs, in a serving cell e.g. SpCell, e.g. PCell, PSCell, SCell etc. Each BWP can be associated with multiple parameters. Examples of such parameters are: BW, e.g. number of time-frequency resources, e.g. resource blocks such as 25 Physical Resource Blocks (PRB) etc., location of BWP in frequency, e.g. starting Resource Block (RB) index of BWP or center frequency, etc., Subcarrier Spacing (SCS), Cyclic P MIMO refix (CP) length, any other baseband parameter, e.g. Multiple Input Multiple Output (MIMO) layer, receivers, transmitters, Hybrid automatic repeat request (HARQ) related parameters etc., etc.

The UE is served, e.g. receive signals such as PDCCH, PDSCH and transmits signals such as PUCCH, PUSCH, in a serving cell only on the active BWP(s). At least one of the configured DL BWPs can be active for reception and at least one of the configured UL BWPs can be active for transmission in each serving cell. The UE can be configured to switch the active BWP based on a timer, e.g. BWP inactivity timer such as bwp-InactivityTimer, by receiving a command or a message from another node, e.g. from the BS, or autonomously by the UE etc. Any active BWP can be switched independently e.g. UL and DL active BWPs can be switched separately. The active BWP switching operation may involve changes in one or more parameters associated with the BWP described above e.g. BW, frequency location, SCS etc. An example of the active BWP switching is illustrated in FIG. 5. The x-axis in FIG. 5 represents time and the y-axis represents frequency. For example, the UE is configured with 4 different BWPs: BWP1, BWP2, BWP3 and BWP4, which are associated with different sets of parameters e.g. BW, SCS, frequency location etc. The UE can be configured to switch its active BWP based on any of a timer, a Downlink Control Information (DCI) command or an RRC message, which also comprises RRC procedure delay e.g. 10 ms. For example, the UE is switched first from the current active BWP1 to new BWP2, which becomes the new active BWP. The active BWP2 is further switched to BWP3, which in turn becomes the new active BWP. The active BWP3 is then further switched to BWP4, which in turn becomes the new active BWP. The new active BWP may be referred to as a current active BWP. The active BWP switching involves delay e.g. X number of slots. The switching delay depend on one or multiple factors e.g. type of BWP switching, numerology of BWP before and after the switching, number of serving cells on which the BWP switching is triggered simultaneously, number of serving cells on which the BWP switching is triggered non-simultaneously, e.g. over partially overlapping time periods etc.

The ATG serving cell radius is very large, e.g. 100-300 km, which means that the UE will stay in the serving cell for a long time, e.g. 10-20 minutes. Therefore, some normal mobility procedures are unnecessary when the UE is staying in the cell center. If the UE applies some of these procedures all the time, then it will increase the UE processing, complexity, memory usage and power consumption. However, the relation between the remaining time until cell expiry and valid procedures isn't specified for ATG UE. The UE's behavior is unclear.

Therefore, there is a need to at least mitigate or solve this issue.

### SUMMARY

An objective is to obviate at least one of the above disadvantages and to provide improved handling of procedures in a communication system.

According to a first aspect, the objective is achieved by a method performed by a UE for adapting procedures in a communication system. The UE is an ATG capable UE. The UE is configured for performing one or more measurements on one or more cells of one or more carrier frequencies. The UE is served by a network node in an ATG cell. The UE determines whether or not the UE is located at least substantially at a cell center of the ATG cell by checking if one or more criteria are met or not. The UE adapts one or more procedures based on a result of the determining.

According to a second aspect, the objective is achieved by a UE for adapting procedures in a communication system. The UE is an ATG capable UE. The UE is configured for performing one or more measurements on one or more cells of one or more carrier frequencies. The UE is served by a network node in an ATG cell. The UE is configured to determine whether or not the UE is located at least substantially at a cell center of the ATG cell by checking if one or more criteria are met or not. The UE is configured to adapt one or more procedures based on a result of the determining.

According to a third aspect, the objective is achieved by a method performed by a network node in a communication system. The network node is an ATG network node. The network node serves an ATG cell. The network node determines whether or not a UE in the ATG cell meets one or more criteria. The network node performs one or more first tasks and/or one or more second tasks. The one or more first tasks are performed when it has been determined that the UE meets the one or more criteria. The one or more second tasks are performed when it has been determined that the UE does not meet the one or more criteria.

According to a fourth aspect, the objective is achieved by a network node in a communication system. The network node is an ATG network node. The network node is configured to serve an ATG cell. The network node is configured to determine whether or not a UE in the ATG cell meets one or more criteria. The network node is configured to perform one or more first tasks and/or one or more second tasks. The one or more first tasks are performed when it has been determined that the UE meets the one or more criteria. The one or more second tasks are performed when it has been determined that the UE does not meet the one or more criteria.

According to a fifth aspect, the objective is achieved by a computer program comprising program code means for performing the methods of any of the first aspect and/or the third aspect when the program is run on a computer.

According to a sixth aspect, the objective is achieved by a computer readable medium carrying a computer program comprising program code means for performing the methods of any of the first aspect and/or the third aspect, when the program product is run on a computer.

The present disclosure herein affords many advantages, of which a non-exhaustive list of examples follows:

An advantage of the present disclosure is that the ATG UE's behavior is defined.

Another advantage of the present disclosure is that it enhances the overall throughput to the UE in the ATG system.

A further advantage of the present disclosure is that the performance of the ATG system is improved.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating an ATG communication system

FIG. 2 is a schematic drawing illustrating an example of the measurement gap pattern in NR.

FIG. 3 is a schematic drawing illustrating examples of scenarios for concurrent measurement gap patterns.

FIG. 4 is a schematic drawing illustrating an example of pre-configured measurement gap pattern in NR.

FIG. 5 is a schematic drawing illustrating examples of active BWP switching.

FIG. 6 is a schematic drawing illustrating a communication system.

FIG. 7 is a signaling diagram illustrating a method.

FIG. 8 is a schematic drawing illustrating an example of UE configured with two sets of carrier frequencies measured by the UE with Pre-MG configuration.

FIG. 9 is a schematic drawing illustrating an example of airplane UE's flightpath

FIG. 10 is a flow chart illustrating a method.

FIG. 11 is a flow chart illustrating a method.

FIG. 12a is a schematic drawing illustrating a UE.

FIG. 12b is a schematic drawing illustrating a UE.

FIG. 13a is a schematic drawing illustrating a network node.

FIG. 13b is a schematic drawing illustrating a network node.

FIG. 14 shows an example of a communication system in accordance with some embodiments.

FIG. 15 is a block diagram of a host, which may be an embodiment of the host of FIG. 14, in accordance with various aspects described herein.

FIG. 16 shows a communication diagram of a host communicating via a network node with a UE over a partially wireless connection in accordance with some embodiments.

The drawings are not necessarily to scale, and the dimensions of certain features may have been exaggerated for the sake of clarity. Emphasis is instead placed upon illustrating the principle.

### DETAILED DESCRIPTION

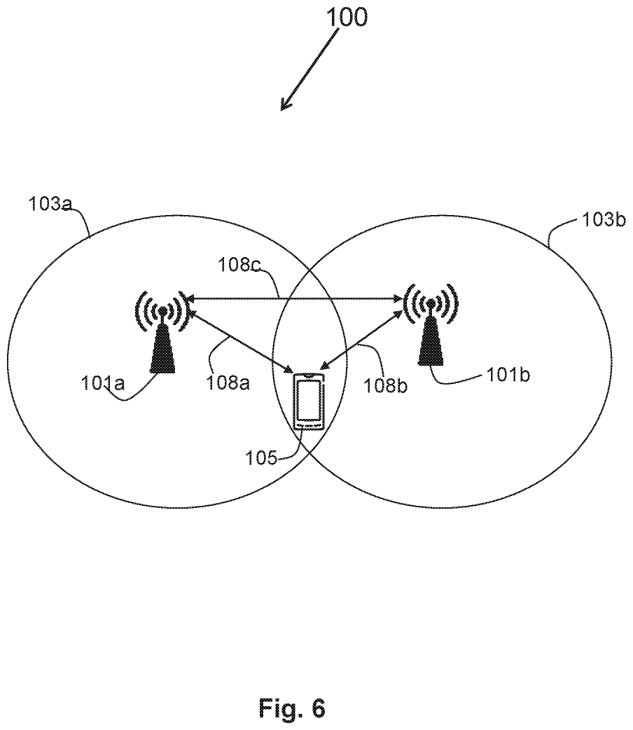

FIG. 6 depicts a non-limiting example of a communications system 100, which may be a wireless communications system, sometimes also referred to as a wireless communications network, cellular radio system, or cellular network, in which the present disclosure may be implemented. The communications system 100 may be a 5G system, 5G network, NR-U or Next Gen system or network. The communications system 100 may alternatively be a younger system or older system than a 5G system, such as e.g. a 2G system, a 3G system, a 4G system, a 6G system a 7G system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

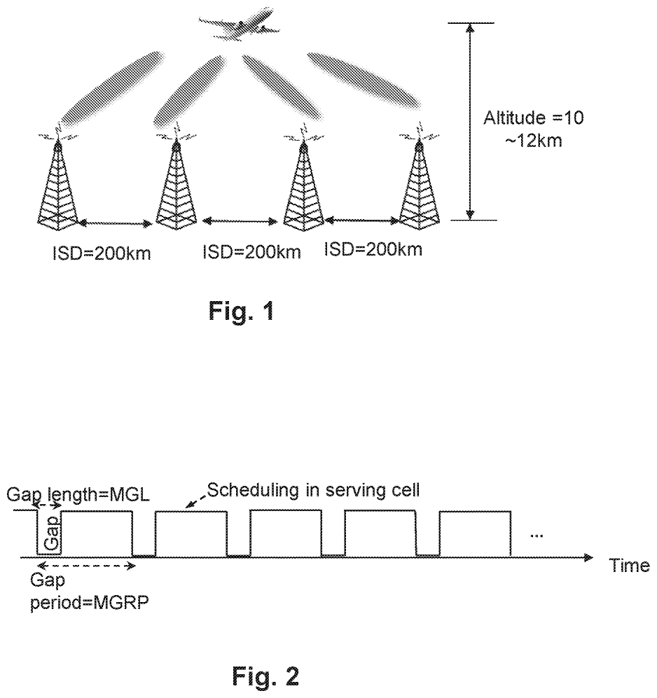

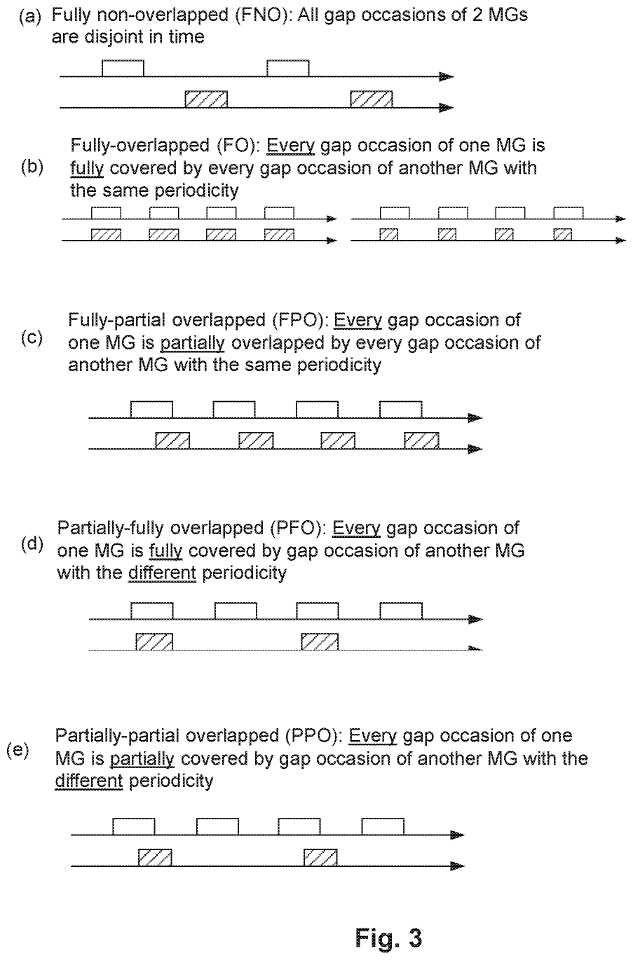

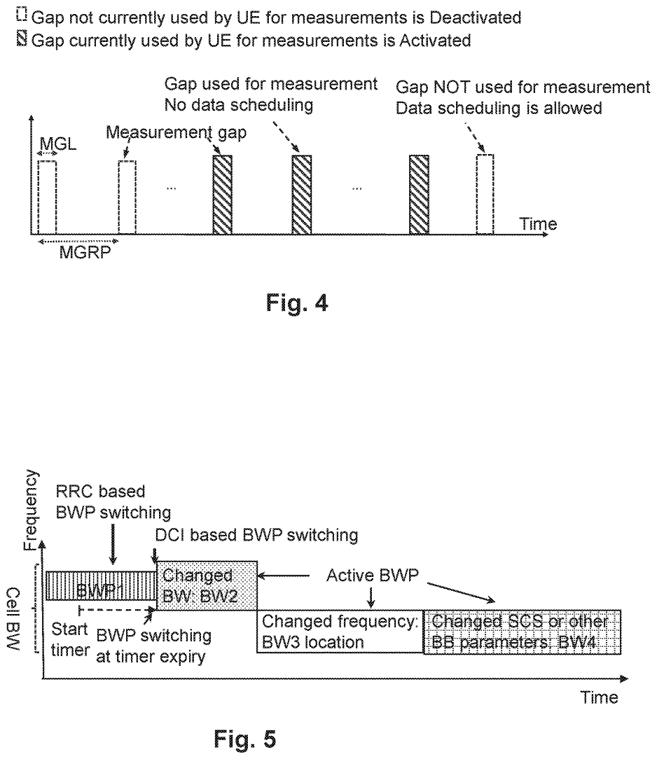

The communications system 100 comprises one or a plurality of network nodes, whereof a first network node 101a and a second network node 101b are depicted in the non-limiting example of FIG. 1. The first network node 101a may be a first ATG network node (NW1) and the second network node 101b may be a second ATG network node (NW2). Any of the first network node 101a, and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas, wherein each cell area may be served by a network node, although, one network node may serve one or several cells. In FIG. 1, the communications system 100 comprises a first cell 103a and a second cell 103b. Note that two cells are exemplified in FIG. 1 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 1, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 1 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e. it refers to any of the first cell 103a or second cell 103b.

One or a plurality of UEs 105 is comprised in the communication system 100. Only one UE 105 is exemplified in FIG. 1 for the sake of simplicity. A UE 105 may also be referred to simply as a device. The UE 105 is an ATG capable UE. The UE 105, e.g. an LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100. The UE 105 may be arranged to be comprised in an airplane.

The UE 105 is enabled to communicate wirelessly within the communications system 100. The communication may be performed e.g. between two UEs 105, between a UE 105 and a regular telephone, between the UE 105 and a network node, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer, e.g. as indicated by the Open Systems Interconnection (OSI) model, as understood by the person skilled in the art.

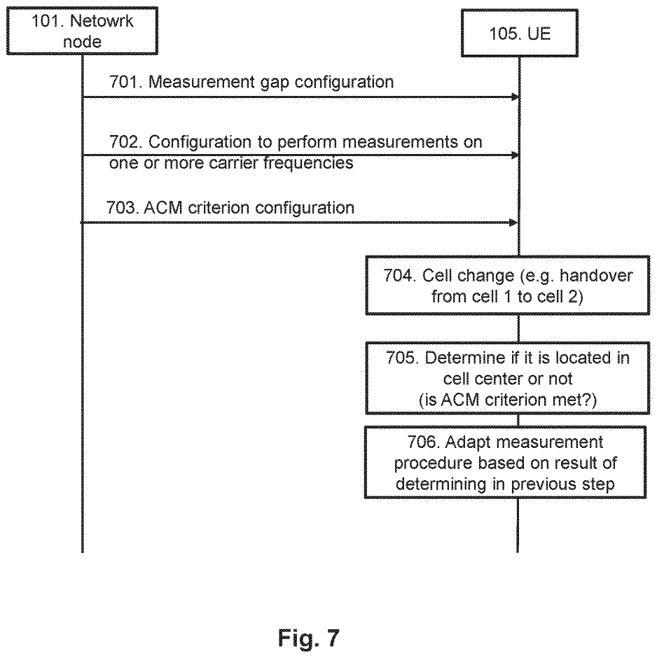

FIG. 7 is a signaling diagram illustrating a method. The method comprises at least one of the following steps, which steps may be performed in any suitable order than described below.

### Step 701

The UE 105 is served by or is located in a first cell 103a, i.e. cell 1. The first cell 103a is managed or served by a first ATG network node 101a, i.e. NW 1. The UE 105 is configured with a pre-configured measurement gap pattern (Pre-MG). The term UE used herein may also be referred to as aerial UE (AUE) or airborne UE which comprises but is not limited to UEs installed on or carried by crewed or uncrewed drones or aircraft such as uncrewed aerial vehicles or airtaxies or air buses or helicopters or commercial airliners.

The UE 105 may be configured by NW1 101a by receiving a message, e.g. measurement gap configuration message, comprising one or more parameters associated with one or more measurement gap patterns e.g. MGRP, MGP, MGTA, MG offset etc. The MGP may be legacy MGP, Pre-MG, concurrent MGP etc.

### Step 702

The UE 105 may be configured by NW1 101a (step 702) to perform measurements on one or more cells operating on one or more carrier frequencies, for example using Pre-MG. This may be realized for example by NW1 101a configuring the UE 105 with information, which can identify the carrier frequencies. An example of such information is a carrier frequency number or identifier such as Absolute Radio Frequency Channel Number (ARFCN). Examples of ARFCN are EUTRA ARFCN (EARFCN), NR-ARFCN etc. EUTRA is short for Evolved UMTS Terrestrial Radio Access and UMTS is short for Universal Mobile Telecommunications System. In general, the UE 105 is configured by NW1 101a with:
1. N number of a first set of carrier frequencies, e.g. SC1, to perform measurements using activated Pre-MG and
2. M number of a second set of carrier frequencies, e.g. SC2, to perform measurements outside Pre-MG

Where N≤1 and M≤0.

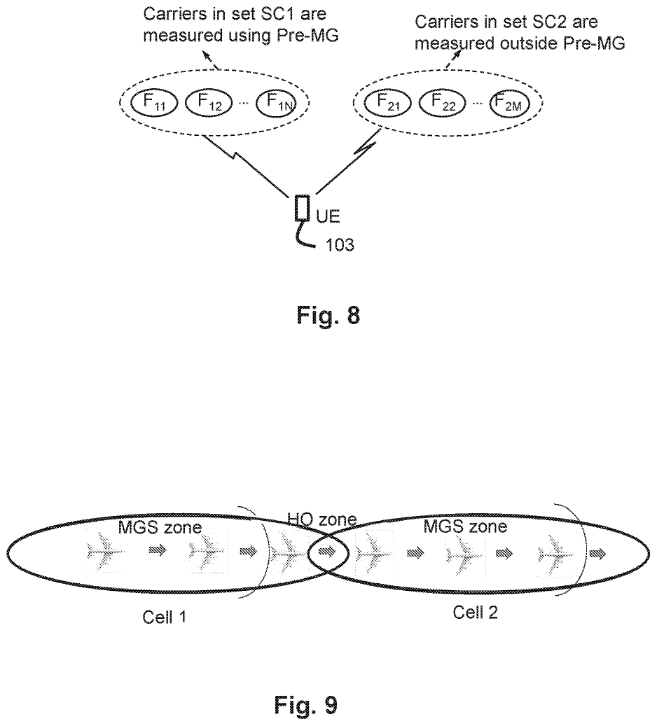

The carrier frequencies belonging to SC1 are denoted by (F₁₁, F₁₂, F₁₃, . . . ,F_{1N}). The carrier frequencies belong to SC2 are denoted by (F₂₁, F₂₂, F₂₃, . . . ,F_{2M}). FIG. 8 illustrates an example showing that the UE 103 is configured to perform measurements on cells of carriers in set SC1 and in set SC2, respectively. FIG. 8 illustrates an example of the UE 105 configured with two sets of carrier frequencies, e.g. SC1 and SC2, measured by the UE 105 with a Pre-MG configuration.

### Step 703

The one or more ACM criteria may be pre-defined and/or configured at the UE 105 by a network node 101, e.g. using RRC, MAC or DCI command.

### Step 704

The airplane housing the UE 105, i.e. AUE, is flying from the first cell(cell1) 103a to second cell (cell2) 103b which is managed or served by NW1 101a or by a second ATG network node (NW2) 101b or by a NW1 101a with different beams. Both the network node (NW) 101 and the UE 105 can predict the flightpath of the airplane embedded UE 105 i.e. AUE. Cell1 103a and cell2 103b may operate on the same carrier frequency, e.g. F1, or on different carrier frequencies, e.g. cell1 and cell2 on F1 and F2 respectively. In the middle zone of the two cells, the UE 105 will perform cell change procedure, e.g. handover procedure, from cell 1 to cell 2. The serving cell's received signal level, e.g. signal strength such as RSRP, signal quality such as RSRQ or SINR etc., will change from the highest level to the lowest level or from a higher value to a relatively lower value. After the cell change, e.g. handover, the serving cell's received signal level, e.g. signal strength, signal quality etc., will change from the lowest level to the highest level gradually or from a lower value to a relatively higher value. This scenario with an example of an airplane UE's flightpath is shown in FIG. 9.

### Step 705

The UE 105 determines or detects or estimates whether the UE 105 is located in center of a serving cell, e.g. Cell1 103a. The UE 105 may perform the determining by checking if one or more ATG cell center mode (ACM) criteria are met or not.

### Step 706

The UE 105 adapts one or more measurement procedures based on the determination in step 705.

The UE 105 determines or detects that the UE 105 is located in the center of the serving cell provided that it meets at least one criterion related to ACM as described below.

The term ACM may refer to a scenario where the UE 105 is located or physically positioned well inside the boundary of a cell or when the UE 105 is not at cell edge etc.

The network node 101 may also disable or deconfigure any one or more of the ACM criteria, which are currently enabled or configured e.g. by sending RRC, MAC or DCI command to the UE 105. The network node 101 may also enable or configure any one or more of the ACM criteria, which are currently disabled or deconfigured e.g. by sending RRC, MAC or DCI command to the UE 105.

### UE Method of Detecting ATG Cell Center Mode (ACM)

As mentioned above, in step 705, the ATG UE 105 determines that it meets one or more ACM criteria provided that at least one of the following conditions is met; otherwise, the UE 105 does not meet the one or more ACM criteria. In the latter case the UE 105 may be located at the cell edge or at least not in the cell center.

Some examples of the ACM criteria will now be described.

### 1. Service Time Based ACM Criterion

The one or more ACM criteria may be met provided that the current time instance, Tin, e.g. current absolute time, is earlier expiry of a service time, if it is configured. The service time may be represented by a parameter such as T_{service}. The Tin may be expressed in terms of UTC time, cell timing or cell counter, e.g. current SFN, hyper-SFN number etc.

The one or more ACM criteria may be met provided that the current time instance, Tin, e.g. current absolute time, is earlier than (T_{service}−Thₜᵢₘₑ₁), if it's configured. Where Thₜᵢₘₑ₁ is a pre-defined time period and (T_{service}−Thₜᵢₘₑ₁) indicates an absolute time prior to T_{service}.
One example of Thₜᵢₘₑ₁ is the time when the UE 105 completed the detection of neighbor cell(s) or satellite(s).
Another example of Thₜᵢₘₑ₁ is Thtime1=K1*SSB/SMTC/DRX, where K1 is predefined number of samples.
Another example of Thₜᵢₘₑ₁ is Thₜᵢₘₑ₁ is certain fixed time period, e.g. 10 s, 20 s, etc.

The one or more ACM criteria may be met provided that the current time instance, Tin, e.g. current absolute time, is earlier than t1-Threshold-r17, if it's configured.

The one or more ACM criteria may be met provided that the current time instance, Tin, e.g. current absolute time, is earlier than t1-Threshold-r17 if it's configured. Where Thₜᵢₘₑ₂ is a pre-defined time period and (T_{service}−Thₜᵢₘₑ₂) indicates an absolute time prior to T_{service}.
One example is Thₜᵢₘₑ₂ is the time when the UE 105 completed the detection of neighbor cell(s) or satellite(s).
Another example is Thₜᵢₘₑ₂=K2*SSB/SMTC/DRX, where K2 is predefined number of samples.
Another example is Thₜᵢₘₑ₂ is certain fixed time period, e.g. 10 s, 20 s, etc.

### 2. Location-Based ACM Criterion

The one or more ACM criteria may be met provided that the distance between UE 105 and serving cell reference location is shorter than a threshold (D_{distanceThresh}), if its configured.

The one or more ACM criteria may be met provided that the distance between UE 105 and serving cell reference location is shorter than (D_{distanceThresh}−th_{dis1}), if its configured. Where th_{dis1} is a pre-defined distance and (D_{distanceThresh}−th_{dis1}) indicates a distance between UE 105 and serving cell reference location short than D_{distanceThresh}.

One example is th_{dis1} is certain fixed distance, e.g. 50 m, 1000 m, etc. In one example, the distance can be measured in vertical, horizontal or 3D plane.

The one or more ACM criteria may be met provided that the distance between UE 105 and serving cell reference location is shorter than referenceLocation1-r17 if its configured.

The one or more ACM criteria may be met provided the distance between UE 105 and target cell reference location is longer than referenceLocation2-r17 if its configured.

The one or more ACM criteria may be met provided that the distance between UE 105 and serving cell reference location is shorter than (referenceLocation1-r17-th_{dis2}), if its configured. Where th_{dis2} is a pre-defined distance and (referenceLocation1-r17-th_{dis2}) indicates a distance between UE 105 and serving cell reference location shorter than referenceLocation1-r17.

One example is th_{dis2} is certain fixed distance, e.g. 50 m, 1000 m, etc.

The one or more ACM criteria may be met provided that the distance between UE 105 and target cell reference location is longer than (referenceLocation2-r17+thdis3), if its configured. Where th_{dis3} is a pre-defined distance and (referenceLocation2-r17+thdis3) indicates a distance between UE 105 and target cell reference location is shorter than referenceLocation2-r17.

One example is thaw is certain fixed distance, e.g. 50 m, 1000 m, etc.

### 3. Received Signal Level-Based ACM Criterion

The one or more ACM criteria may be met provided that the Received Signal Level (RSL) at the ATG UE 105 with respect to a cell, e.g. Cell1, is larger than Th1_{power}. The RSL is measured or estimated by the UE 105 on a reference signal transmitted by the cell, e.g. Cell1. Examples of RSL are signal strength, signal quality etc. Examples of signal strength are path loss, RSRP, NRSRP etc. Examples of signal quality are RSSI, RSRQ, NRSRQ, SNR, SINR, Channel state information (CSI) measurement. e.g. CQI etc. The related RS can be CRS, NRS, CSI-RS, SSB, PRS etc. The examples can be expressed in the equation as: Srxlev>Th1_{power}.

The one or more ACM criteria may be met provided that the UE 105 is configured with ‘t-Service’ and the RSL>Th2_{power} and T_{service} is earlier than t1-Threshold-r17.

The one or more ACM criteria may be met provided that the UE 105 is not configured with ‘t-Service’ and the RSL>Th3_{power}.

The one or more ACM criteria may be met provided that the UE 105 estimated or measured a first RSL (Srx,1) at or around time, T1, and after some time, the UE 105 estimated or measured a second RSL (Srx,2) at or around time, T2, are related to each other by a relation. For example, the one or more ACM criteria is met provided that the following condition is met:

$$( Srx , 2 - Srx , 1 ) > Th {4}_{power}$$

### Where,

$$T 2 > T 1$$

Th4_{power} is a threshold which can be pre-defined or configured by a network node e.g. by NW1.

### 4. Cell Change Timer-Based ACM Criterion

When ATG UE 105 finishes the cell change procedure in step 704, e.g. the handover procedure, RRC connection release with redirection etc., then the UE 105 will stay in the new serving cell for a long time depending on the AUE speed and/or size of the serving cell. For example, the UE 105 will stay in the new serving cell for several minutes, a time above a time threshold etc.

The UE 105 may start a timer upon completing a cell change procedure, i.e. upon starting to being served by a new cell. The UE 105 may start the timer after step 704 has been performed. The UE 105 may start the timer after sending an UL signal, e.g.

Physical Random Access Channel (PRACH) such as preamble, to a new serving cell as part of the cell change procedure. The UE 105 may start the timer after receiving a higher layer message, e.g. a HO acknowledgement message, from a new serving cell or the network node 101 serving the new serving cell as part of the cell change procedure. The timer may also be called as a cell change timer e.g. HO timer.

The one or more ACM criteria may be met provided that the timer which starts when UE 105 finishes the cell change procedure, e.g. handover procedure, and transmits the UL signal, e.g. PRACH, to a new serving cell, hasn't expired.

The one or more ACM criteria may be met provided that the value of the cell change timer, which starts upon completion of the cell change procedure, e.g. handover procedure, is below a certain threshold (HT1). HT1 may be pre-defined or configured by a network node 101. In one example, HT1 may be X1 percentage, e.g. 30%, of the timer value.

### UE Adaptive Measurement Procedures Upon Meeting One or More ACM Criteria

If the UE 105 meets at least one ACM criterion, as described in previous section, then the UE 105 may adapt a first set of one or more measurement procedures as described below with examples.

An ATG UE 105 may evaluate whether at least one carrier frequency belonging to the first set, SC1, meets at least one ACM criterion. If the UE 105 determines, based on the evaluation, that the carriers in SC1 meet at least one ACM criterion, then the UE 105 may deactivate the Pre-MG and/or disable the MG and/or suspend one MG in ConMGs.

The ATG UE 105 may perform one or more measurements on one or more cells of one or more carriers belonging to the second set SC2.

The ATG UE 105 may use the measurement results and/or the results of the carriers for performing one or more operational tasks. Examples of the operational tasks are described later in this section.

Rules for Activating and/or Deactivating the Pre-MG

Whether the UE 105 activates and/or deactivates the Pre-MG, may depend on one or more rules associated with the UE 105 meeting the one or more ACM criteria. The UE 105 may use any of the one or more ACM criteria and/or their combinations to decide whether to activate and/or deactivate the Pre-MG.

### Examples of Rules are Described Below:

1. In one example of the rule, the UE 105 may deactivate the Pre-MG provided that one or both of the following conditions are met; otherwise the Pre-MG remains activated:
   a. UE 105 may meet a time-based ACM, and/or
   b. The RS for intra-frequency measurements is within the active BWP of the UE 105.
The UE 105 may disable or do not perform one or more measurements on one more non-serving carrier frequencies. For example:
   The UE 105 may disable inter-frequency measurements on one more inter-frequency carrier frequencies, and/or
   The UE 105 may disable inter-RAT measurements on one more inter-RAT carrier frequencies, e.g. an LTE carrier frequency.
2. In another example of the rule, the UE 105 may deactivate the Pre-MG provided that one or both of the following conditions are met; otherwise the Pre-MG remains activated:
   a. UE 105 may meet a location-based ACM, and/or
   b. The RS for intra-frequency measurements may be within the active BWP of the UE 105.
The UE 105 may disable or do not perform one or more measurements on one more non-serving carrier frequencies; otherwise the Pre-MG remains activated. For example:
   The UE 105 may disable inter-frequency measurements on one more inter-frequency carrier frequencies, and/or
   The UE 105 may disable inter-RAT measurements on one more inter-RAT carrier frequencies, e.g. LTE carrier frequency.
3. In another example of the rule, the UE 105 may activate the Pre-MG provided that at least one of the following conditions is met; otherwise the Pre-MG remains deactivated:
   a. UE 105 may NOT meet any ACM criteria, and/or
   b. The RS for intra-frequency measurements is outside the active BWP of the UE 105.
4. In another example of the rule, the UE 105 may activate the Pre-MG provided that at least one of the following conditions is met; otherwise the Pre-MG remains activated:
   a. UE 105 may NOT meet any of the one or more ACM criteria, and/or
   b. The UE 105 may not be configured with the BWP or the active BWP is equal to the configured bandwidth of the UE 105.
      Rules for Configuring and/or Deconfiguring the MG or One MG in ConMGs

Whether the UE 105 may release and/or deconfigure the MG or one MG in ConMGs, may depend on one or more rules associated with the UE 105 meeting the one or more ACM criteria. The UE 105 may use any of the one or more ACM criteria and/or their combinations to decide whether to configure and/or deconfigure the MG. Examples of rules are described below:
1. In one example of the rule, the UE 105 may release and/or de-configure the MG or at least one MG in Con-MGs provided that one or both of the following conditions are met; otherwise the UE 105 does not release/de-configure any of the MG:
   a. UE 105 may a meet time-based ACM criterion, and/or
   b. The other frequency layers' measurements in the MG don't need MG.
   The UE 105 may disable or may not perform one or more measurements on one more non-serving carrier frequencies; otherwise the Pre-MG remains activated. For example:
   The UE 105 may disable inter-frequency measurements on one more inter-frequency carrier frequencies, and/or
   The UE 105 may disable inter-RAT measurements on one more inter-RAT carrier frequencies, e.g. LTE carrier frequency.
2. In one example of the rule, the UE 105 may release and/or de-configure the MG or at least one MG in Con-MGs provided that one or both of the following conditions are met; otherwise the UE 105 does not release and/or de-configure any of the MG:
   a. UE 105 may meet a location-based ACM criterion and may disable all inter-frequency measurements, and/or
   b. The other frequency layers' measurements in the MG don't need MG.
3. In another example of the rule, the UE 105 may configure the MG or Con-MGs provided that at least one of the following conditions is met; otherwise the UE 105 may not release/de-configure any of the MG:
   a. UE 105 may NOT meet any of the one or more ACM criteria, and/or
   b. The other frequency layers' measurements in the MG needs MG

### Rules to Limit the Total Number of Inter-Frequency Measurements

Instead of suspending the MG or deactivating the Pre-MG, the UE 105 may limit the total number of non-serving carriers, e.g. inter-frequency carrier, inter-RAT carrier etc., for performing the measurements, e.g. inter-frequency measurements, depending on meeting one or more ACM criteria and/or their combinations. When the at least one of the ACM criteria is met, then only N inter-frequency measurements are predicted. For example, N=1 and N is a positive integer.

The network node 101 may configure or pre-configure the UE 105 with a first list of non-serving carriers, e.g. a list of inter-frequency carriers and/or with a list of inter-RAT carriers etc., which are to be measured when the UE 105 meets one or more ACM criteria. When the UE 105 determines that one or more ACM criteria is met, then the UE 105 only performs the measurements on the carriers which are comprised in the configured first list of the carriers e.g. the inter-frequency carrier(s) which is in the list.

The network node 101 may configure or pre-configure the UE 105 with a second list of non-serving carriers, which are not required to be measured by the UE 105 when the UE 105 meets one or more ACM criteria. When the UE 105 determines that one or more ACM criteria is met, then the UE 105 does not perform any measurement on any carrier which is comprised in the configured second list of the carriers e.g. the inter-frequency carrier(s) which is in the list.

The UE 105 may autonomously decide or determine which one or more of the configured non-serving carriers, e.g. inter-frequency carrier(s), inter-RAT carrier(s) etc., are to be measured by the UE 105 when one or more ACM criteria is met. The UE 105 may perform the measurements on the determined one or more carriers.

The UE 105 may autonomously decide or determine which one or more of the configured non-serving carriers, e.g. inter-frequency carrier(s), inter-RAT carrier(s) etc., are NOT required to be measured by the UE 105 when one or more ACM criteria is met. The UE 105 does not perform any measurement on the determined one or more carriers.

The UE 105 may autonomously decide or determine which one or more of the configured non-serving carriers are to be measured and/or which one or more of the configured non-serving carriers are NOT required to be measured based on one or more ACM criteria. Examples of the ACM criteria may be: RSL, frequency range of the carrier, frequency band of the carrier, relation with respect to the frequency of the serving carrier, historical data or statistics etc. For example, the UE 105 measures carriers whose RSL is above a certain first threshold (H1m). The UE 105 does not measure carriers whose RSL is below a certain second threshold (H2m). In another example, the UE 105 may measure on carriers which are in the same band as of the serving carrier frequency. The UE 105 does not measure carriers which are in a band which is different than the band of the serving carrier frequency.

The total number limitation rule may be applied to both CONNECTED mode and IDLE/INACTIVE mode measurement procedures.

Some examples will now be provided. Assume that the ATG UE 105 is configured with the Pre-MG. The UE 105 is configured with two carrier frequencies, F11 and F12, in the first set SC1. F11 is an intra-frequency layer. F12 is an inter-frequency layer in inter-band. The UE 105 determines that the BW of the RS, e.g. SSB, for measurements on F11 is not within the active BWP of the serving cell of the UE 105. The two carriers in SC1 are to be measured by Pre-MG. The Pre-MG is activated.

After a while, the UE 105 detects it's not at the ATG cell edge based on the time service parameter configured by network node 101. The UE 105 will suspend the inter-frequency F12 measurements and only perform the intra-frequency measurement for PCell. The network node 101 will configure the BWP switching to guarantee the BW of the RS, e.g. SSB, for measurements on F11 is within the active BWP of the serving cell. The measurements on F11 will adapt to SC2 which is gapless measurement. The Pre-MG can be deactivated. This in turn increases the ATG user data rate and the overall ATG system throughput.

### Examples of Operational Tasks:

Examples of one or more operational tasks which the UE 105 may perform are:
1. Using the measurement results for one or more procedures. Examples of procedures are cell change, positioning etc.
2. Storing or logging the measurement results for period of time. The UE 105 may transmit the results to a network node 101, e.g. NW1, at a future time.
3. Transmitting the measurement results to a network node 101, e.g. to NW1.
4. Transmitting information indicating whether the UE 105 has met one or more ACM criteria to a network node 101 e.g. via RRC, MAC etc. The UE 105 informs the network node 101 if the UE 105 met one or more ACM criteria and/or if the UE 105 had not met one or more ACM criteria. The transmitted information may indicate the one or more criteria, e.g. identifiers of pre-configured ACM criteria, the UE 105 has met and/or the one or more criteria, e.g. identifiers of pre-configured ACM criteria, the UE 105 has not met.
   UE Adaptive RRC Re-Establishment or RRC Connection Release with Redirection Procedures Upon Meeting ACM Criteria
   Rules to Select the Target Candidate Cells for RRC Re-Establishment or RRC Connection Release with Redirection Procedures

How to select the target candidate cells in RRC re-establishment procedure may depend on one or more rules associated with the UE 105 meeting the one or more ACM criteria. The UE 105 can use any of the one or more ACM criteria and/or their combinations to decide the target candidate cells. Examples of rules are described below:

The total re-establishment delay equation is as follows:

$${T}_{UE \_ re - establish \_ delay} = 50 ms + {T}_{identity \_ intra \_ NR} + {\sum }_{i = 1}^{{N}_{freq} - 1} {T}_{identity \_ inter \_ NR , i} + {T}_{SI - NR} + {T}_{PRACH}$$

In one example of the rule, the UE 105 adapts RRC re-establishment procedures with serving cells when the one or more ACM criteria is met. Otherwise the UE 105 won't select the serving cells as the possible target cells in RRC re-establishment. Where, T_{identify_intra_NR}=0 when none of the one or more ACM criteria is met.

In one example of the rule, the UE 105 adapts The RC re-establishment procedures without inter-frequencies or with the limited inter-frequencies when one or more ACM criteria is met. Otherwise, the UE 105 will select the total number of NR frequencies to be monitored for RRC re-establishment.

Where, T_{identify_inter_NR,i}=0 when the ACM is met.

In one example, the network node 101 configures or pre-configures the UE 105 with a first list of non-serving carriers, e.g. a list of inter-frequency carriers and/or with a list of inter-RAT carriers etc., which will be used for RRC re-establishment or RRC Connection Release with Redirection when the UE 105 meets one or more ACM criteria. When the UE 105 determines that one or more ACM criteria is met then the UE 105 only performs the RRC re-establishment or RRC Connection Release with Redirection on the carriers which are comprised in the configured first list of the carriers e.g. the inter-frequency carrier(s) which is in the list. In this example, the total number N_{freq} can be limited by the configured list.

### Adapting or Triggering a RRC Re-Establishment Procedure:

In one example, if the UE 105 does not meet any of the one or more ACM criteria or if does not meet service time based ACM criterion, then the UE 105 adapts the RRC connection re-establishment procedure to another cell. For example, if the current time (Tin) of the UE 105 is equal to or larger than T_{service} or (T_{service}−Thₜᵢₘₑ₁), then the UE 105 initiates an RRC connection re-establishment procedure to another cell.

### Adapting or Triggering Radio Link Problem Related Procedures:

In another example, if the UE 105 does not meet any of the one or more ACM criteria or if does not meet service time based ACM criterion, then the UE 105 starts a timer or a counter, e.g. increment on frame level. In one example, upon the expiry of the timer, the UE 105 initiates an RRC connection re-establishment procedure to another cell. In another example, upon the expiry of the timer, the UE 105 declares a detection of a radio link problem in the current serving cell e.g. radio link failure, beam failure etc. Subsequently, the UE 105 may perform one or more procedures or take one or more actions. Examples of such actions are initiating candidate beam detection, performing beam failure recovery, performing RRC connection re-establishment procedure to another cell etc.

In another example, the network node 101 configures or pre-configures the UE 105 with a second list of non-serving carriers, which are not required to be selected by the UE 105 for RRC re-establishment or RRC Connection Release with Redirection when the UE 105 meets one or more ACM criteria. When the UE 105 does not meet any of the one or more ACM criteria or if the UE 105 does not meet one or more specific ACM criteria (as described in previous section) then the UE 105 does not perform RRC re-establishment or RRC Connection Release with Redirection on any carrier which is comprised in the configured second list of the carriers e.g. the inter-frequency carrier(s) which is in the list. In this example, the total number N_{freq} can be limited by the configured list.

In another example, the UE 105 autonomously decides or determines which one or more of the configured non-serving carriers, e.g. inter-frequency carrier(s), inter-RAT carrier(s) etc., are to be the target candidate cells for RRC re-establishment or RRC Connection Release with Redirection by the UE when one or more ACM criteria is met. The UE 105 performs the RRC re-establishment or RRC Connection Release with Redirection on the determined one or more carriers. In this example, the total number N_{freq} can be reduced.

In another example, the UE 105 autonomously decides or determines which one or more of the configured non-serving carriers, e.g. inter-frequency carrier(s), inter-RAT carrier(s) etc., are NOT required in the target candidate cells for RRC re-establishment or RRC Connection Release with Redirection by the UE 105 when one or more ACM criteria is met. The UE 105 does not perform RRC re-establishment or RRC Connection Release with Redirection on the determined one or more carriers. In this example, the total number N_{freq} can be reduced.

The UE 105 autonomously decides or determines which one or more of the configured non-serving carriers are in the target candidate cell list and/or which one or more of the configured non-serving carriers are NOT required to be in the target candidate cell list based on one or more ACM criteria. Examples of the ACM criteria are: RSL, frequency range of the carrier, frequency band of the carrier, relation with respect to the frequency of the serving carrier, historical data or statistics etc. For example the UE 105 measures carriers whose RSL is above a certain first threshold (H1m). The UE 105 does not perform RRC re-establishment or RRC Connection Release with Redirection on carriers whose RSL is below a certain second threshold (H2m). In another example, the UE 105 measures carriers which are in the same band as of the serving carrier frequency. The UE 105 does not perform RRC re-establishment or RRC Connection Release with Redirection on carriers which are in a band which is different than the band of the serving carrier frequency.

### UE Adaptive Conditional Handover Procedures Upon Meeting ACM Criteria Rules for the Candidate Cell for Conditional Handover Procedures

How to select the target candidate cells in conditional handover procedure may depend on one or more rules associated with the UE 105 meeting the one or more ACM criteria. The UE 105 can use any of the one or more ACM criteria and/or their combinations to decide the target candidate cells. Examples of rules are described below:

In one example, the network node 101 configures or pre-configures the UE 105 with a first list of non-serving carriers, e.g. a list of inter-frequency carriers and/or with a list of inter-RAT carriers etc., which will be used for conditional handover when the UE meets one or more ACM criteria. When the UE 105 determines that one or more ACM criteria is met, then the UE 105 only performs the conditional handover on the carriers which are comprised in the configured first list of the carriers e.g. the inter-frequency carrier(s) which is in the list.

In another example, the network node 101 configures or pre-configures the UE 105 with a second list of non-serving carriers, which are not required to be selected by the UE 105 for conditional handover when the UE 105 meets one or more ACM criteria. When the UE does not meet any of the one or more ACM criteria or if the UE 105 does not meet one or more specific one or more ACM criteria, as described in previous section, then the UE 105 does not perform conditional handover on any carrier which is comprised in the configured second list of the carriers e.g. the inter-frequency carrier(s) which is in the list.

In another example, the UE 105 autonomously decides or determines which one or more of the configured non-serving carriers, e.g. inter-frequency carrier(s), inter-RAT carrier(s) etc., are to be the target candidate cells for conditional handover by the UE 105 when one or more ACM criteria is met. The UE 105 performs the conditional handover on the determined one or more carriers.

In another example, the UE 105 autonomously decides or determines which one or more of the configured non-serving carriers, e.g. inter-frequency carrier(s), inter-RAT carrier(s) etc., are NOT required in the target candidate cells for conditional handover by the UE 105 when one or more ACM criteria is met. The UE 105 does not perform conditional handover on the determined one or more carriers.

The UE 105 autonomously decides or determines which one or more of the configured non-serving carriers are in the target candidate cell list and/or which one or more of the configured non-serving carriers are NOT required to be in the target candidate cell list based on one or more ACM criteria. Examples of the ACM criteria are: RSL, frequency range of the carrier, frequency band of the carrier, relation with respect to the frequency of the serving carrier, historical data or statistics etc. For example, the UE 105 measures carriers whose RSL is above a certain first threshold (H1m). The UE does not conditional handover on carriers whose RSL is below a certain second threshold (H2m). In another example, the UE 105 measures carriers which are in the same band as of the serving carrier frequency. The UE 105 does not perform conditional handover on carriers which are in a band which is different than the band of the serving carrier frequency.

### NW 101 Method of Adapting MG Status

An ATG network node 101 may evaluate or determine whether the UE 105 meets at least one ACM criterion and may perform one or more tasks based on the determination. The one or more tasks may be operational tasks. The one or more tasks may be a first task and/or a second task.

The network node 101 uses the same one or more ACM criteria as described earlier, to determine whether the UE 105 meets the one or more ACM criteria. The determination may be related to carrier frequencies belonging to the first set, SC1 meets at least one ACM criterion described herein.

Examples of the tasks are described below.

If the network node 101 determines that the UE 105 meets at least one of the ACM criteria, then the network node 101 performs one or more of the following tasks, e.g. first tasks:
If the network node 101 determines, based on the evaluation, the carriers in SC1 meet at least one ACM criterion then the network node 101 deconfigures and/or releases the MG or deactivates and/or disables the Pre-MG. The network node 101 determines whether scheduling restriction shall be enabled for the gap depending on the MG and its status, e.g. deactivated Pre-MG or released MG.
The ATG network node 101 may continue to schedule the UE 105 on downlink and uplink during radio time that does not overlap with the measurement gap. Whether the network node 101 schedules the UE 105 during the radio time overlapped by the disabled measurement gap may depend on whether there is data in buffers to transmit to and/or from UE 105, the network node load situation, e.g. number of UEs 105 in a cell, available channels/radio resources such as resource blocks etc., the latency tolerated by the services provided to the UE 105, e.g. whether the UE 105 is operating according to low-latency requirements or not, etc.

If the network node 101 determines that the UE 105 does not meet any of the one or more ACM criteria or does not meet one or more particular ACM criteria, e.g. service time related ACM criterion, then the network node 101 performs one or more of the following tasks, i.e. second tasks.

In one example, the network node 101 triggers the UE 105 to perform a cell change to another cell e.g. handover, RRC connection release with redirection.

In this disclosure, the term node is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (LAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc), O & M, OSS, SON, positioning node (e.g. E-SMLC), etc.

The term UE refers to any type of wireless device communicating with a network node and/or with another UE in a cellular or mobile communication system. Examples of UE are target device, air-to-ground (ATG) UE, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc. In some embodiments the non-limiting term aerial UE (AUE) is used, and it refers to any type of UE equipped or housed or located in any type of flying object. The flying object moves or flies in air or in free space. The term flying object is interchangeably called flying vehicle, aerial vehicle (AV), aerial object, aerial device, IAB node, air to ground (ATG) UE etc. Examples of the flying object are aircraft, drone, chopper, helicopter, flying balloon, glider, flying bus etc. In some embodiments aerial vehicle (AV) may also refer to aerial UE (AUE).

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs. The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are symbol, time slot, subframe, radio frame, TTI, interleaving time, slot, sub-slot, mini-slot, SFN cycle, hyper-SFN (H-SFN) cycle etc.

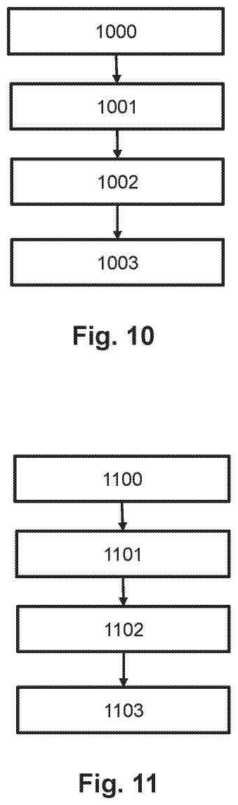

The method described above will now be described from the perspective of the UE 105. FIG. 10 is a flowchart describing the present method in the UE 105, for adapting procedures in a communication system 100. The UE 105 is an ATG capable UE. The UE 105 is configured for performing one or more measurements on one or more cells of one or more carrier frequencies. The UE 105 is served by a network node 101 in an ATG cell. The UE 105 may be configured with a MGP for performing the one or more measurements on one or more cells of one or more carrier frequencies.

The method comprises at least one of the following steps to be performed by the UE 105, which steps may be performed in any suitable order than described below:

### Step 1000

This step corresponds to step 701, step 702 and step 703 in FIG. 7. The UE 105 may obtain, from the network node 101, a MG configuration or pre-MG configuration associated with at least one list of non-serving frequency carriers. The UE 105 may obtain information indicating the one or more criteria from the network node 101, i.e. the one or more criteria listed in step 1002 below.

### Step 1001

The UE 105 may obtain, from the network node 101, a trigger or request for determining whether or not the UE 105 is located at least substantially at a cell center of the ATG cell. When the UE 105 is located at least substantially at the cell center, it may comprise that the UE 105 is located at the cell center with some tolerance with respect to the distance from the cell center. The term at least substantially may refer to that the UE 105 is located at the cell center, and/or that the UE 105 is located at the cell center with some tolerance.

The UE 105 may obtain information indicating the one or more criteria from the network node 101, i.e. the one or more criteria listed in step 1002 below.

### Step 1002

This step corresponds to step 705 in FIG. 7. The UE 105 determines whether or not the UE 105 is located at least substantially at a cell center of the ATG cell by checking if one or more criteria are met or not. The one or more criteria may be one or more ACM criteria.

The UE 105 may be determined to be located at least substantially at the cell center when the one or more criteria are met. The UE 105 may be determined to not be at least substantially at the cell center when the one or more criteria are not met.

The one or more criteria may comprise one or more of the following:
that a reference time is earlier than expiry of a service time by more than a certain margin, and/or
that a distance between a UE reference location and the ATG cell reference location is shorter than a distance threshold, and/or
that a received signal level of the UE 105 is larger than a signal level threshold, and/or
that a cell change timer has not expired after the UE 105 has completed a cell change procedure.

The service time may be a Tservice parameter.

The UE 105 may perform the determining in one or more of the following ways:
continuously, and/or
periodically, and/or
at regular time intervals, and/or
upon receiving a request, and/or
when triggered, and/or
at a predetermined time instance, as preconfigured by the network node, and/or
when the received signal level of the serving cell changes e.g. falls below a threshold.

### Step 1003

This step corresponds to step 706 in FIG. 7. The UE 105 adapts one or more procedures based on a result of the determining in the previous step. Step 1003 may be described as performing one or more procedures based on a result of the determining in the previous step.

The MGP may be a legacy MG, and the one or more procedures may comprise that the UE 105 suspends the legacy MG when it has been determined that the UE 105 is located at least substantially at the cell center.

The MGP may be a pre-MG, and the one or more procedures may comprise that the UE 105 deactivate the pre-MG when it has been determined that the UE 105 is located at least substantially at the cell center.

The one or more procedures may comprise that the UE 105 may release at least one MG when it has been determined that the UE 105 is located at least substantially at the cell center.

The one or more procedures may comprise that the UE 105 may disable the performing of at least one measurement when it has been determined that the UE 105 is located at least substantially at the cell center.

The one or more procedures may comprise that the UE 105 may reduce a number of non-serving carrier frequency layers to measure when it has been determined that the UE 105 is located at least substantially at the cell center.

The one or more procedures may comprise that the UE 105 may initiate a RRC connection re-establishment to another cell when it has been determined that the UE 105 is not located at least substantially at the cell center.

The one or more procedures may comprise that the UE 105 may start a timer when it has been determined that the UE 105 is not located at least substantially at the cell center. When the timer has expired, the UE 105 may determine that a communication link problem in the communication system 100 has been detected. In other words, the expiry of the timer is an indication of that there is a communication link problem in the communication system 100.

A computer program comprising program code means for performing the method of FIG. 7 and/or FIG. 10 when the program is run on a computer. A computer readable medium carries a computer program comprising program code means for performing the method of FIG. 7 and/or FIG. 10, when the program product is run on a computer. The computer may be for example comprised in the UE 105, in a processing circuitry comprised in the UE 105 etc.

The method described above will now be described from the perspective of the network node 101. FIG. 11 is a flowchart describing the present method in the network node 101 for adapting procedures in a communication system 100. The network node 101 is an ATG network node. The network node 101 serves an ATG cell. The method comprises at least one of the following steps to be performed by the network node 101, which steps may be performed in any suitable order than described below:

### Step 1100

This step corresponds to step 701, step 702 and step 703 in FIG. 7. The network node 101 may perform a MG configuration or pre-configuration of the UE 105 with at least one list of non-serving frequency carriers. The network node 101 may provide information indicating the one or more criteria to the UE 105 in step 1100, i.e. the one or more criteria listed in step 1102 below.

### Step 1101

The network node 101 may provide, to the UE 105, a trigger or request for determining whether or not the UE 105 is located at least substantially at a cell center of the ATG cell. The network node 101 may provide information indicating the one or more criteria to the UE 105 in step 1101, i.e. the one or more criteria listed in step 1102 below.

### Step 1102

The network node 101 determines whether or not a UE 105 in the ATG cell meets one or more criteria. The one or more criteria may be one or more ACM criteria.

The one or more criteria may comprise one or more of the following:
that a reference time is earlier than expiry of a service time by more than a certain margin, and/or
that a distance between a UE reference location and the ATG cell reference location is shorter than a distance threshold, and/or
that a received signal level of the UE 105 is larger than a signal level threshold, and/or
that a cell change timer has not expired after the UE 105 has completed a cell change procedure.

The criteria used by the network node 101 may be the same as the UE 105 used in step 1002 in FIG. 10.

### Step 1103

The network node 101 performs one or more first tasks and/or one or more second tasks. The one or more first tasks are performed when it has been determined that the UE 105 meets the one or more criteria. The one or more second tasks are performed when it has been determined that the UE 105 does not meet the one or more criteria.

The one or more first tasks may comprise one or more of:
the network node 101 may deconfigure and/or release a legacy MG; or
the network node 101 may deactivate and/or disable a pre-MG; or
the network node 101 may determine, based on a status of the legacy MG or the pre-MG, whether or not to enable a scheduling restriction for a gap associated with the legacy MG or the pre-MG.

The one or more first tasks may comprise that the network node 101 may continue scheduling the UE 105 on a downlink and uplink during a radio time that does not overlap with a MG.

The one or more second tasks may comprise that the network node 101 may trigger the UE 105 to perform a cell change from the ATG cell to another cell.

A computer program comprising program code means for performing the method of FIG. 7 and/or FIG. 11 when the program is run on a computer. A computer readable medium carries a computer program comprising program code means for performing the method of FIG. 7 and/or FIG. 11, when the program product is run on a computer. The computer may be for example comprised in the network node 101, in a processing circuitry comprised in the network node 101 etc.

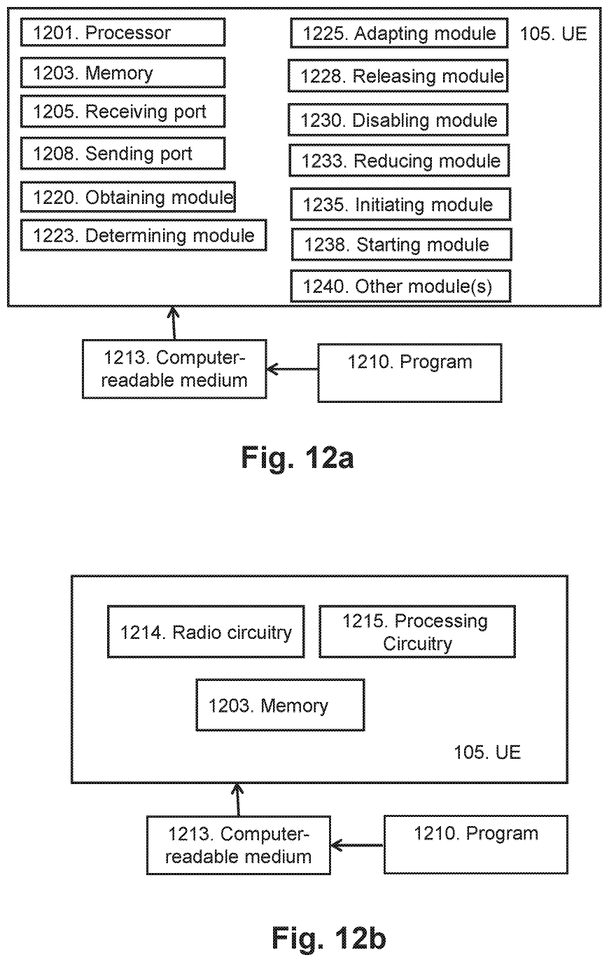

FIG. 12a and FIG. 12b depict two different examples in panels a) and b), respectively, of the arrangement that the UE 105 may comprise. The UE 105 may comprise the following arrangement depicted in FIG. 12a.

The present disclosure related to the UE 105 may be implemented through one or more processors, such as a processor 1201 in the UE 105 depicted in FIG. 12a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 105. One such carrier may be in the form of a CD ROM disc. It is however feasible with other data carriers such as a memory stick. The computer program code may be provided as pure program code on a server and downloaded to the UE 105.

The UE 105 may comprise a memory 1203 comprising one or more memory units. The memory 1203 is arranged to be used to store obtained information, store data, configurations, schedulings, and applications etc. to perform the methods herein when being executed in the UE 105.

The UE 105 may receive information from, e.g. the network node 101, through a receiving port 1205. The receiving port 1205 may be, for example, connected to one or more antennas in UE 105. The UE 105 may receive information from another structure in the communications system 100 through the receiving port 1205. Since the receiving port 1205 may be in communication with the processor 1201, the receiving port 1205 may then send the received information to the processor 1201. The receiving port 1205 may also be configured to receive other information.

The processor 1201 in the UE 105 may be configured to transmit or send information to e.g. network node 101 or another structure in the communications system 100, through a sending port 1208, which may be in communication with the processor 1201, and the memory 1203.

Thus, the methods described herein for the UE 105 may be respectively implemented by means of a computer program 1210 product, comprising instructions, i.e., software code portions, which, when executed on at least one processor 1001, cause the at least one processor 1201 to carry out the actions described herein, as performed by the UE 105. The computer program 1210 product may be stored on a computer-readable storage medium 1213. The computer-readable storage medium 1213, having stored thereon the computer program 1210, may comprise instructions which, when executed on at least one processor 1201, cause the at least one processor 1201 to carry out the actions described herein, as performed by the UE 105. The computer-readable storage medium 1213 may be a non-transitory computer-readable storage medium, such as a CD ROM disc, or a memory stick. The computer program 1210 product may be stored on a carrier containing the computer program 1210 just described, wherein the carrier is one of an electronic signal, optical signal, radio signal, or the first computer-readable storage medium 1213, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 12b. The UE 105 may comprise a processing circuitry 1215, e.g., one or more processors such as the processor 1201, in the UE 105 and the memory 1203. The UE 105 may also comprise a radio circuitry 1214, which may comprise e.g., the receiving port 1205 and the sending port 1208. The processing circuitry 1215 may be configured to, or operable to, perform the method actions herein, in a similar manner as that described in relation to FIG. 12a. The radio circuitry 1214 may be configured to set up and maintain at least a wireless connection with the UE 105. Circuitry may be understood herein as a hardware component.

Hence, the present disclosure also relates to the UE 105 operative to operate in the communications system 100. The UE 105 may comprise the processing circuitry 1215 and the memory 1203. The memory 1203 comprises instructions executable by said processing circuitry 1001. The UE 105 is operative to perform the actions described herein in relation to the UE 105.

The UE 105 may be configured to, e.g. by means of an obtaining module 1220 or the processing circuitry 1215, obtain, from the network node 101, a MG configuration or pre-MG configuration associated with at least one list of non-serving frequency carriers. The obtaining module 1220 may also be referred to as an obtaining unit, an obtaining means, an obtaining circuit, means for obtaining etc. The obtaining module 1220 may be a processor 1201 or the processing circuitry 1215 of the UE 105 or comprised in the processor 1201 or the processing circuitry 1215 of the UE 105.

The UE 105 may be configured to, e.g. by means of the obtaining module 1220 or the processing circuitry 1215, obtain, from the network node 101, a trigger or request for determining whether or not the UE 105 is located at least substantially at a cell center of the ATG cell. When the UE 105 is located at least substantially at the cell center, it may comprise that the UE 105 is located at the cell center with some tolerance with respect to the distance from the cell center. The term at least substantially may refer to that the UE 105 is located at the cell center, and/or that the UE 105 is located at the cell center with some tolerance.

The UE 105 is configured to, e.g. by means of a determining module 1223 or the processing circuitry 1215, determine whether or not the UE 105 is located at least substantially at a cell center of the ATG cell by checking if one or more criteria are met or not. The determining module 1223 may also be referred to as a determining unit, a determining means, a determining circuit, means for determining etc. The determining module 1223 may be a processor 1201 or the processing circuitry 1215 of the UE 105 or comprised in the processor 1201 or the processing circuitry 1215 of the UE 105.

The UE 105 may be determined to be located at least substantially at the cell center when the one or more criteria are met. The UE 105 may be determined to not be at least substantially at the cell center when the one or more criteria are not met.

The one or more criteria may comprise one or more of the following:
that a reference time is earlier than expiry of a service time by more than a certain margin, and/or
that a distance between a UE reference location and the ATG cell reference location is shorter than a distance threshold, and/or
that a received signal level of the UE 105 is larger than a signal level threshold, and/or
that a cell change timer has not expired after the UE 105 has completed a cell change procedure.

The service time may be a Tservice parameter.

The UE 105 may be configured to perform the determining in one or more of the following ways:
continuously, and/or
periodically, and/or
at regular time intervals, and/or
upon receiving a request, and/or
when triggered, and/or
at a predetermined time instance, as preconfigured by the network node, and/or
when the received signal level of the serving cell changes e.g. falls below a threshold.

The UE 105 may be configured to, e.g. by means of an adapting module 1225 or the processing circuitry 1215, adapt one or more procedures based on a result of the determining in the previous step. The adapting module 1225 may also be referred to as an adapting unit, an adapting means, an adapting circuit, means for adapting etc. The adapting module 1225 may be a processor 1201 or the processing circuitry 1215 of the UE 105 or comprised in the processor 1201 or the processing circuitry 1215 of the UE 105.

The MGP may be a legacy MG, and the one or more procedures may comprise that the UE 105 suspends the legacy MG when it has been determined that the UE 105 is located at least substantially at the cell center.

The MGP may be a pre-MG, and the one or more procedures may comprise that the UE 105 deactivate the pre-MG when it has been determined that the UE 105 is located at least substantially at the cell center.

The one or more procedures may comprise that the UE 105 may be configured to, e.g. by means of a releasing module 1228 or the processing circuitry 1215, release at least one MG when it has been determined that the UE 105 is located at least substantially at the cell center. The releasing module 1228 may also be referred to as a releasing unit, a releasing means, a releasing circuit, means for releasing etc. The releasing module 1228 may be a processor 1201 or the processing circuitry 1215 of the UE 105 or comprised in the processor 1201 or the processing circuitry 1215 of the UE 105.

The one or more procedures may comprise that the UE 105 may be configured to, e.g. by means of a disabling module 1230 or the processing circuitry 1215, disable the performing of at least one measurement when it has been determined that the UE 105 is located at least substantially at the cell center. The disabling module 1230 may also be referred to as a disabling unit, a disabling means, a disabling circuit, means for disabling etc. The disabling module 1230 may be a processor 1201 or the processing circuitry 1215 of the UE 105 or comprised in the processor 1201 or the processing circuitry 1215 of the UE 105.

The one or more procedures may comprise that the UE 105 may be configured to, e.g. by means of a reducing module 1233 or the processing circuitry 1215, reduce a number of non-serving carrier frequency layers to measure when it has been determined that the UE 105 is located at least substantially at the cell center. The reducing module 1233 may also be referred to as a reducing unit, a reducing means, a reducing circuit, means for reducing etc. The reducing module 1233 may be a processor 1201 or the processing circuitry 1215 of the UE 105 or comprised in the processor 1201 or the processing circuitry 1215 of the UE 105.

The one or more procedures may comprise that the UE 105 may be configured to, e.g. by means of an Initiating module 1235 or the processing circuitry 1215, initiate a RRC connection re-establishment to another cell when it has been determined that the UE 105 is not located at least substantially at the cell center. The initiating module 1235 may also be referred to as an initiating unit, an initiating means, an initiating circuit, means for initiating etc. The initiating module 1235 may be a processor 1201 or the processing circuitry 1215 of the UE 105 or comprised in the processor 1201 or the processing circuitry 1215 of the UE 105.

The one or more procedures may comprise that the UE 105 may be configured to, e.g. by means of a starting module 1238 or the processing circuitry 1215, start a timer when it has been determined that the UE 105 is not located at least substantially at the cell center. When the timer has expired, the UE 105 may determine that a communication link problem in the communication system 100 has been detected. In other words, the expiry of the timer is an indication of that there is a communication link problem in the communication system 100. The starting module 1238 may also be referred to as a starting unit, a starting means, a starting circuit, means for starting etc. The starting module 1238 may be a processor 1201 or the processing circuitry 1215 of the UE 105 or comprised in the processor 1201 or the processing circuitry 1215 of the UE 105.

The UE 105 may comprise the obtaining module 1220, the determining module 1223, the adapting module 1225, the releasing module 1228, the disabling module 1230, the reducing module 1233, the initiating module 1235, the starting module 1238, other module(s) 1240 etc.

Those skilled in the art will also appreciate that the obtaining module 1220, the determining module 1223, the adapting module 1225, the releasing module 1228, the disabling module 1230, the reducing module 1233, the initiating module 1235, the starting module 1238, other module(s) 1240 described above may refer to a combination of analogue and digital circuits, and/or one or more processors configured with software and/or firmware, e.g., stored in memory, that, when executed by the one or more processors such as the processor 1201, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 1220-1240 described above may be implemented as one or more applications running on one or more processors such as the processor 1201 or the processing circuitry 1215.

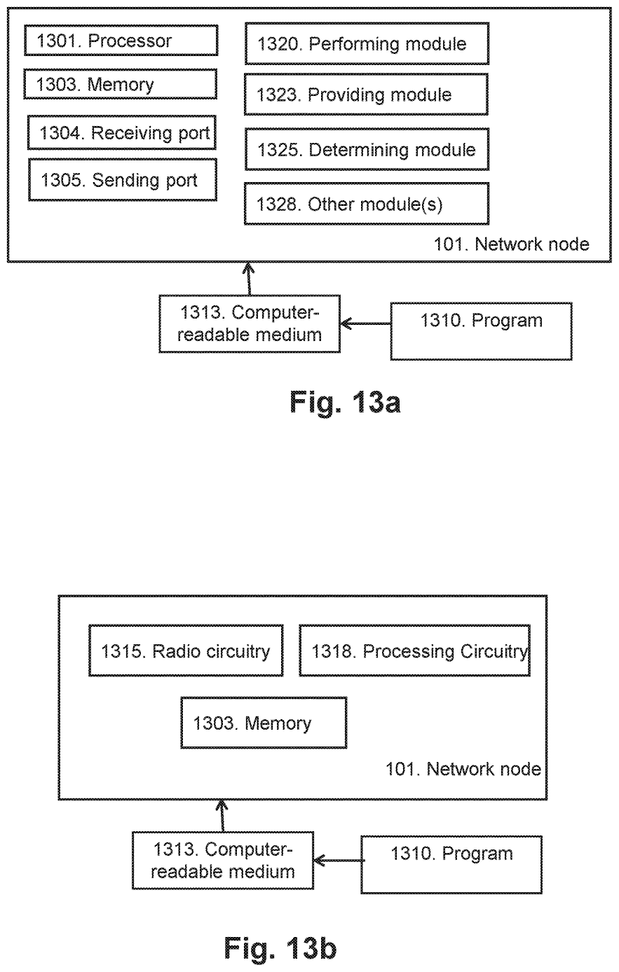

FIG. 13a and FIG. 13b depict two different examples in panels a) and b), respectively, of the arrangement that the network node 101 may comprise. The network node 101 may comprise the following arrangement depicted in FIG. 13a.

The present disclosure associated with the network node 101 may be implemented through one or more processors, such as a processor 1301 in the network node 101 depicted in FIG. 13a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 1303 comprising one or more memory units. The memory 1303 is arranged to be used to store obtained information, store data, configurations, schedulings, and applications etc. to perform the methods herein when being executed in the network node 101.

The network node 101 may receive information from, e.g., the UE 105, through a receiving port 1304. The receiving port 2004 may be, for example, connected to one or more antennas in network node 101. The network node 101 may receive information from another structure in the communications system 100 through the receiving port 1304. Since the receiving port 1304 may be in communication with the processor 1301, the receiving port 2004 may then send the received information to the processor 1301. The receiving port 1304 may also be configured to receive other information.

The processor 2001 in the network node 101 may be configured to transmit or send information to e.g., the UE 105, or another structure in the communications system 100, through a sending port 1305, which may be in communication with the processor 1301, and the memory 1303.

Thus, the methods described herein for the network node 101 may be respectively implemented by means of a computer program 1310 product, comprising instructions, i.e., software code portions, which, when executed on at least one processor 1301, cause the at least one processor 1301 to carry out the actions described herein, as performed by the network node 101. The computer program 1310 product may be stored on a computer-readable storage medium 1313. The computer-readable storage medium 1313, having stored thereon the computer program 1310, may comprise instructions which, when executed on at least one processor 1301, cause the at least one processor 1301 to carry out the actions described herein, as performed by the network node 101. The computer-readable storage medium 1313 may be a non-transitory computer-readable storage medium, such as a CD ROM disc, or a memory stick. The computer program 1310 product may be stored on a carrier containing the computer program 1310 just described, wherein the carrier is one of an electronic signal, optical signal, radio signal, or the second computer-readable storage medium 1313, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 200b. The network node 101 may comprise a processing circuitry 1315, e.g., one or more processors such as the processor 1301, in the network node 101 and the memory 1303. The network node 101 may also comprise a radio circuitry 1318, which may comprise e.g., the receiving port 1304 and the sending port 1305. The processing circuitry 1315 may be configured to, or operable to, perform the method actions described herein in a similar manner as that described in relation to FIG. 13a. The radio circuitry 1318 may be configured to set up and maintain at least a wireless connection with the network node 101. Circuitry may be understood herein as a hardware component.

The network node 101 may be operative to operate in the communications system 100. The network node 101 may comprise the processing circuitry 1315 and the memory 1303. The memory 1303 comprises instructions executable by the processing circuitry 1315. The network node 101 is operative to perform the actions described herein in relation to the network node 101.

The network node 101 may be configured to, e.g. by means of a performing module 1320 or the processing circuitry 1315, perform a MG configuration or pre-configuration of the UE 105 with at least one list of non-serving frequency carriers. The performing module 1320 may also be referred to as a performing unit, a performing means, a performing circuit, means for performing etc. The performing module 1320 may be a processor 1301 or the processing circuitry 1318 of the network node 101 or comprised in the processor 1301 or the processing circuitry 1318 of the network node.

The network node 101 may be configured to, e.g. by means of a providing module 1323 or the processing circuitry 1315, provide, to the UE 105, a trigger or request for determining whether or not the UE 105 is located at least substantially at a cell center of the ATG cell. The providing module 1323 may also be referred to as a providing unit, a providing means, a providing circuit, means for providing etc. The providing module 1323 may be a processor 1301 or the processing circuitry 1318 of the network node 101 or comprised in the processor 1301 or the processing circuitry 1318 of the network node.

The network node 101 is configured to, e.g. by means of a determining module 1325 or the processing circuitry 1315, determine whether or not a UE 105 in the ATG cell meets one or more criteria. The determining module 1325 may also be referred to as a determining unit, a determining means, a determining circuit, means for determining etc. The determining module 1325 may be a processor 1301 or the processing circuitry 1318 of the network node 101 or comprised in the processor 1301 or the processing circuitry 1318 of the network node.

The one or more criteria may comprise one or more of the following:
that a reference time is earlier than expiry of a service time by more than a certain margin, and/or
that a distance between a UE reference location and the ATG cell reference location is shorter than a distance threshold, and/or
that a received signal level of the UE 105 is larger than a signal level threshold, and/or
that a cell change timer has not expired after the UE 105 has completed a cell change procedure.

The criteria used by the network node 101 may be the same as the UE 105 used in step 1002 in FIG. 10.

The network node 101 is configured to, e.g. by means of the performing module 1320 or the processing circuitry 1315, perform one or more first tasks and/or one or more second tasks. The one or more first tasks are performed when it has been determined that the UE 105 meets the one or more criteria. The one or more second tasks are performed when it has been determined that the UE 105 does not meet the one or more criteria.

The one or more first tasks may comprise one or more of:
the network node 101 may deconfigure and/or release a legacy MG; or
the network node 101 may deactivate and/or disable a pre-MG; or
the network node 101 may determine, based on a status of the legacy MG or the pre-MG, whether or not to enable a scheduling restriction for a gap associated with the legacy MG or the pre-MG.

The one or more first tasks may comprise that the network node 101 may continue scheduling the UE 105 on a downlink and uplink during a radio time that does not overlap with a MG.

The one or more second tasks may comprise that the network node 101 may trigger the UE 105 to perform a cell change from the ATG cell to another cell.

The network node 101 may comprise the performing module 1320, the providing module 1323, the determining module 1325, other module(s) 1328 etc.

Those skilled in the art will also appreciate that the performing module 1320, the providing module 1323, the determining module 1325, other module(s) 1328 described above may refer to a combination of analogue and digital circuits, and/or one or more processors configured with software and/or firmware, e.g., stored in memory, that, when executed by the one or more processors such as the processor 1301, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 1320-1328 described above may be implemented as one or more applications running on one or more processors such as the processor 1301 or the processing circuitry 1318.

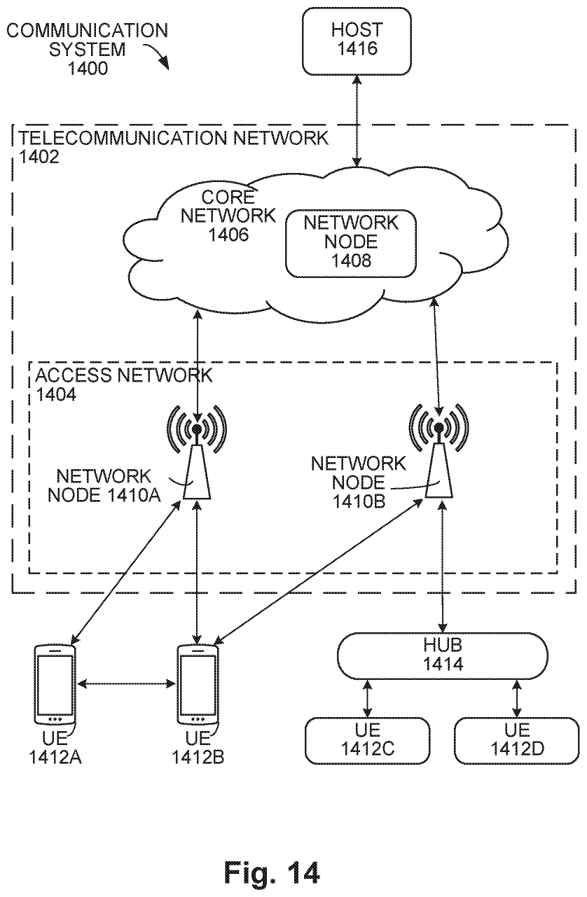

FIG. 14 shows an example of a communication system 1400 in accordance with some embodiments.

In the example, the communication system 1400 comprises a telecommunication network 1402 that comprises an access network 1404, such as a radio access network (RAN), and a core network 1406, which comprises one or more core network nodes 1408. The access network 1404 comprises one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection comprise transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may comprise any number of wired or wireless networks, network nodes, UEs, and/or any other components or systems that may facilitate or participate in the communication of data and/or signals whether via wired or wireless connections. The communication system 1400 may comprise and/or interface with any type of communication, telecommunication, data, cellular, radio network, and/or other similar type of system.

The UEs 1412 may be any of a wide variety of communication devices, comprising wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 comprises one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes comprise functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications comprise live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that comprise, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

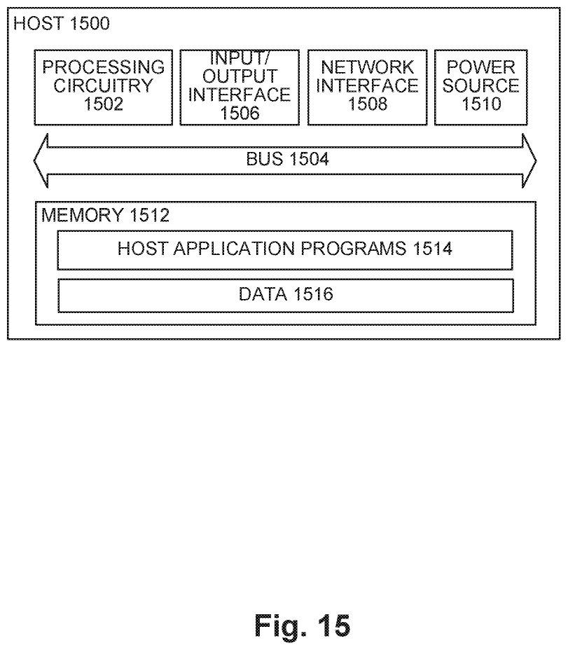

FIG. 15 is a block diagram of a host 1500, which may be an embodiment of the host 1416 of FIG. 14, in accordance with various aspects described herein. As used herein, the host 1500 may be or comprise various combinations hardware and/or software, comprising a standalone server, a blade server, a cloud-implemented server, a distributed server, a virtual machine, container, or processing resources in a server farm. The host 1500 may provide one or more services to one or more UEs.

The host 1500 comprises processing circuitry 1502 that is operatively coupled via a bus 1504 to an input/output interface 1506, a network interface 1508, a power source 1510, and a memory 1512. Other components may be comprised in other embodiments. Features of these components may be substantially similar to those described with respect to the devices of previous FIGURES, such that the descriptions thereof are generally applicable to the corresponding components of host 1500.

The memory 1512 may comprise one or more computer programs comprising one or more host application programs 1514 and data 1516, which may comprise user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), comprising transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

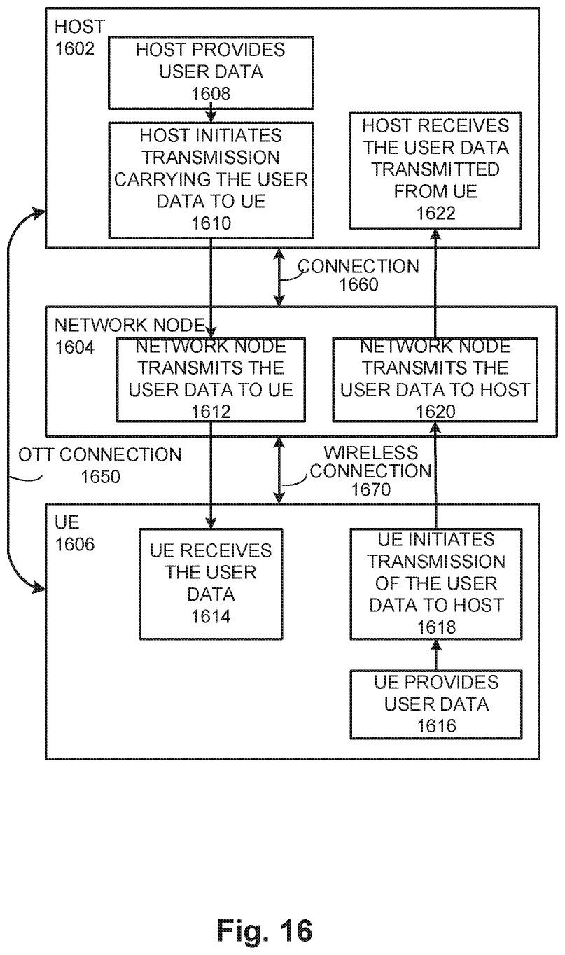

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1412a of FIG. 14), network node (such as network node 1410a of FIG. 14), and host (such as host 1416 of FIG. 14 and/or host 1500 of FIG. 15) discussed in the preceding paragraphs will now be described with reference to FIG. 16.

Like host 1500, embodiments of host 1602 comprise hardware, such as a communication interface, processing circuitry, and memory. The host 1602 also comprises software, which is stored in or accessible by the host 1602 and executable by the processing circuitry. The software comprises a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 comprises hardware enabling it to communicate with the host 1602 and UE 1606. The connection 1660 may be direct or pass through a core network (like core network 1406 of FIG. 14) and/or one or more other intermediate networks, such as one or more public, private, or hosted networks. For example, an intermediate network may be a backbone network or the Internet.

The UE 1606 comprises hardware and software, which is stored in or accessible by UE 1606 and executable by the UE's processing circuitry. The software comprises a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may comprise message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Some embodiments may be summarized as follows:

The present disclosure relates to adaptive mobility procedures based on ATG cell validity time.

An ATG capable UE 105, e.g. aerial UE, configured with a measurement gap pattern (MGP) for performing one or more measurements on one or more cells of one or more carrier frequencies. The UE 105 is served by an ATG cell (Cell1) e.g. by a ground base station. The MGP can be a legacy MG or a Pre-MG.

The UE 105 may determine whether it is located or positioned in the center of the ATG cell (e.g. Cell1) based on one or more rules, and adapts one or more procedures based on the determination. The UE 105 determines that it is located or positioned in the ATG cell center provided that at least one of the following criteria is met; otherwise the determines that it is not located or positioned in the ATG cell center. In the latter case the UE 105 may be located at the cell edge.
When a reference time (Tr), e.g. current time instance, is earlier than Tserivce by more than certain margin then the UE 105 is located in the cell center.
When the distance between UE reference location, e.g. UE current location, and the serving cell reference location is shorter than a threshold, e.g. DdistanceThresh, then the UE 105 is located in the cell center.
When the received signal level, e.g. signal quality, of the ATG UE 105 is larger than a threshold (Th1power) then the UE 105 is located in the cell center.
When cell change timer, e.g. the HO timer, has not expired after the UE 105 has completed the cell change procedure, e.g. handover procedure, RRC connection release with redirection) then the UE is located in the cell center.

The UE 105 may suspend the MG when UE 105 detects that it is located inside or staying in the ATG cell center.

The UE 105 may deactivate Pre-MG when UE 105 detects that it is located inside or staying in the ATG cell center.

The UE 105 may reduce the number of non-serving carrier frequency layers to measure, e.g. reduces inter-frequency measurements and/or inter-RAT measurements, when UE 105 detects that it is located inside or staying in ATG cell center. The UE 105 may initiate RRC connection re-establishment to another cell, e.g. to a target cell, when UE 105 detects that it is NOT located inside or is NOT staying in ATG cell center.

The UE 105 may start a timer when the UE 105 detects that it is NOT located inside or is NOT staying in ATG cell center. Upon the expiry of the timer the UE 105 may declare that it has detected a radio link problem e.g. beam failure detection etc.

The ATG UE 105 may be configured to be allowed to deactivate the gap upon triggering certain conditions.

A host configured to operate in a communication system to provide an over-the-top (OTT) service, the host comprising:
processing circuitry configured to provide user data; and
a network interface configured to initiate transmission of the user data to a network node 30 in a cellular network for transmission to a UE 105, the network node 101 having a communication interface and processing circuitry, the processing circuitry of the network node configured to perform the following operations to transmit the user data from the host to the UE 105:
determine whether or not the UE 105 meets at least one ACM criteria;
when it has been determined that the UE 105 meets at least one ACM criteria, perform one or more first tasks; and
when it has been determined that the UE 105 does not meet at least one ACM criteria, perform one or more second tasks.

The host of the previous embodiment, wherein:
the processing circuitry of the host is configured to execute a host application that provides the user data; and
the UE 105 comprises processing circuitry configured to execute a client application associated with the host application to receive the transmission of user data from the host.

A method implemented in a host configured to operate in a communication system that further comprises a network node and a UE 105, the method comprising:
providing user data for the UE 105; and
initiating a transmission carrying the user data to the UE 105 via a cellular network comprising the network node 101, wherein the network node 101 performs the following operations to transmit the user data from the host to the UE 105:
determining whether or not the UE 105 meets at least one ACM criteria;
when it has been determined that the UE 105 meets at least one ACM criteria, performing one or more first tasks; and
when it has been determined that the UE 105 does not meet at least one ACM criteria, performing one or more second tasks.

The method of the previous embodiment, further comprising, at the network node 101, transmitting the user data provided by the host for the UE 105.

The method of any of the previous embodiments, wherein the user data is provided at the host by executing a host application that interacts with a client application executing on the UE 105, the client application being associated with the host application.

A communication system configured to provide an over-the-top service, the communication system comprising:
a host comprising:
processing circuitry configured to provide user data for a UE 105, the user data being associated with the over-the-top service; and
a network interface configured to initiate transmission of the user data toward a cellular network node for transmission to the UE 105, the network node having a communication interface and processing circuitry, the processing circuitry of the network node 101 configured to perform the following operations to transmit the user data from the host to the UE 105:
determine whether or not the UE 105 meets at least one ACM criteria;
when it has been determined that the UE 105 meets at least one ACM criteria, perform one or more first tasks; and
when it has been determined that the UE 105 does not meet at least one ACM criteria, perform one or more second tasks.

The communication system of the previous embodiment, further comprising:
the network node 101; and/or
the UE 105.

The communication system of the previous embodiments, wherein:
the processing circuitry of the host is configured to execute a host application, thereby providing the user data; and
the host application is configured to interact with a client application executing on the UE 105, the client application being associated with the host application.

A host configured to operate in a communication system to provide an over-the-top (OTT) service, the host comprising:
processing circuitry configured to provide user data; and
a network interface configured to initiate transmission of the user data to a cellular network for transmission to a UE 105, wherein the UE 105 comprises a communication interface and processing circuitry, the communication interface and processing circuitry of the UE 105 being configured to perform the following operations to receive the user data from the host:
determining whether or not the UE 105 is at least substantially at a cell center of the cell; and
adapting one or more procedures based on the result of the determining.

The host of the previous embodiment, wherein the cellular network further comprises a network node 101 configured to communicate with the UE 105 to transmit the user data to the UE 105 from the host.

The host of the previous embodiments, wherein:
the processing circuitry of the host is configured to execute a host application, thereby providing the user data; and
the host application is configured to interact with a client application executing on the UE 105, the client application being associated with the host application.

A method implemented by a host operating in a communication system that further comprises a network node and a UE 105, the method comprising:
providing user data for the UE 105; and
initiating a transmission carrying the user data to the UE 105 via a cellular network comprising the network node 101, wherein the UE 105 performs the following operations to receive the user data from the host:
determining whether or not the UE 105 is at least substantially at a cell center of the cell; and
adapting one or more procedures based on the result of the determining.

The method of the previous embodiment, further comprising:
at the host, executing a host application associated with a client application executing on the UE 105 to receive the user data from the UE 105.

The method of the previous embodiment, further comprising:
at the host, transmitting input data to the client application executing on the UE 105, the input data being provided by executing the host application,
wherein the user data is provided by the client application in response to the input data from the host application.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A method performed by a User Equipment (UE) for adapting procedures in a communication system, wherein the UE is an Air-to-ground (ATG) capable UE, wherein the UE is configured for performing one or more measurements on one or more cells of one or more carrier frequencies, wherein the UE is served by a network node in an ATG cell, the method comprising:
determining whether or not the UE is located at least substantially at a cell center of the ATG cell by checking if one or more criteria are met or not; and
adapting one or more procedures based on a result of the determining.

2. The method according to claim 1, wherein the UE is determined to be located at least substantially at the cell center when the one or more criteria are met; and
wherein the UE is determined to not be at least substantially at the cell center when the one or more criteria are not met

3. The method according to claim 1, wherein the one or more criteria comprises one or more of the following:
that a reference time is earlier than expiry of a service time by more than a certain Margin; and/or
that a distance between a UE reference location and the ATG cell reference location is shorter than a distance threshold; and/or
that a received signal level of the UE is larger than a signal level threshold; and/or
that a cell change timer has not expired after the UE has completed a cell change procedure.

4. The method according to claim 1, wherein the UE is configured with a Measurement Gap Pattern (MGP) for performing the one or more measurements on one or more cells of one or more carrier frequencies.

5. The method according to claim 4, wherein the MGP is a legacy Measurement Gap (MG), and wherein the one or more procedures comprises:
suspending the legacy MG when it has been determined that the UE is located at least substantially at the cell center.

6. The method according to claim 4, wherein the MGP is a pre-Measurement Gap (pre-MG), and wherein the one or more procedures comprises:
deactivating the pre-MG when it has been determined that the UE is located at least substantially at the cell center.

7. The method according to claim 1, wherein the one or more procedures comprises:
releasing at least one Measurement Gap (MG), when it has been determined that the UE is located at least substantially at the cell center.

8. The method according to claim 1, wherein the one or more procedures comprises:
disabling the performing of at least one measurement when it has been determined that the UE is located at least substantially at the cell center.

9. The method according to claim 1, wherein the one or more procedures comprises:
reducing a number of non-serving carrier frequency layers to measure when it has been determined that the UE is located at least substantially at the cell center.

10. The method according to claim 1, wherein the one or more procedures comprises:
initiating a Radio Resource Control (RRC), connection re-establishment to another cell when it has been determined that the UE is not located at least substantially at the cell center.

11. The method according to claim 1, wherein the one or more procedures comprises:
starting a timer when it has been determined that the UE is not located at least substantially at the cell center; and
when the timer has expired, determining that a communication link problem in the communication system has been detected.

12. The method according to claim 1, comprising:
obtaining, from the network node, a trigger or request for determining whether or not the UE is located at least substantially at a cell center of the ATG cell.

13. The method according to claim 1, comprising:
obtaining, from the network node, a Measurement Gap (MG) configuration or pre-configuration associated with at least one list of non-serving frequency carriers.

14. A User Equipment (UE) in a communication system, wherein the UE is an Air-to-ground (ATG) capable UE, wherein the UE is configured for performing one or more measurements on one or more cells of one or more carrier frequencies, wherein the UE is served by a network node in an ATG cell; and
wherein the UE is configured to:
determine whether or not the UE is located at least substantially at a cell center of the ATG cell by checking if one or more criteria are met or not; and
adapt one or more procedures based on a result of the determining.

15. A computer program comprising program code means for performing the method of claim 1 when the program is run on a computer.

16. A computer readable medium carrying a computer program comprising program code means for performing the method of claim 1 when the program product is run on a computer.

17. A method performed by a network node in a communication system, wherein the network node is an Air-to-ground (ATG), network node, wherein the network node serves an ATG cell, the method comprising:
determining whether or not a User Equipment (UE) in the ATG cell meets one or more criteria; and
performing one or more first tasks and/or one or more second tasks,
wherein the one or more first tasks are performed when it has been determined that the UE meets the one or more criteria; and
wherein the one or more second tasks are performed when it has been determined that the UE does not meet the one or more criteria.

18. The method according to claim 17, further comprising:
performing a Measurement Gap (MG) configuration or pre-configuration of the UE with at least one list of non-serving frequency carriers.

19. The method according to claim 17, wherein the one or more criteria comprises one or more of the following:
that a reference time is earlier expiry of a service time by more than a certain margin; and/or
that a distance between a UE reference location and the ATG cell reference location is shorter than a distance threshold; and/or
that a received signal level of the UE is larger than a signal level threshold; and/or
that a cell change timer has not expired after the UE has completed a cell change procedure.

20. The method according to claim 17, wherein the one or more first tasks comprises one more of:
deconfiguring and/or releasing a legacy Measurement Gap (MG); or
deactivating and/or disabling a pre-Measurement Gap (pre-MG); or
determining, based on a status of the legacy MG or the pre-MG, whether or not to enable a scheduling restriction for a gap associated with the legacy MG or the pre-MG.

21.-26. (canceled)
